(19) United States
(12) Patent Application Publication
(10) Pub. No.: US 2024/0128434 A1
(43) Pub. Date: Apr. 18, 2024

(54) BATTERY ELECTRODE AND MANUFACTURE THEREOF

(71) Applicant: Rivian IP Holdings, LLC, Plymouth, MI (US)

(72) Inventors: Meng Wang, Pleasanton, CA (US); Ashwin Krishna Murali, Dublin, CA (US); Ki Tae Park, Santa Clara, CA (US); Harold Tan Dimagiba, Fremont, CA (US)

(21) Appl. No.: 18/046,265

(22) Filed: Oct. 13, 2022

(51) Int. Cl. H01M 4/04

(52) U.S. Cl. CPC H01M 4/0435

(57) ABSTRACT

A system can include a calendaring device. The calendar device can include a first roller and a second roller. The calendaring device can apply a force to a material between the first roller and the second roller to form a web. The system can include a notching device to cut the web to form a tab. The web can be provided from the calendaring device to the notching device.

### INTRODUCTION

Electric vehicles can use batteries to drive a motor and otherwise power the electric vehicle. The batteries can include electrical and mechanical components that can hold an electrical charge.

### SUMMARY

A system for manufacturing a battery electrode can include a calendaring device and a notching device. The calendaring device can be a calendar-laminator or a calendaring device. For example, a calendar-laminator can apply a force (e.g., a shearing force or a compressive force) to a material to form a film. The calendar-laminator can laminate (e.g., adhere, join) the film with at least one side of a current collector material to form a web. A calendaring device can apply a force to a material to form a web. The web, whether formed by a calendaring device or a calendar-laminator, can be provided to the notching device. For example, the web can be provided from the calendaring device or the calendar-laminator to the notching device via a web handling device. The calendaring device (e.g., the calendar-laminator or the calendaring device) and the notching device can be part of the same system (e.g., integrated, operatively coupled) rather than discrete and disconnected devices. The notching device can include a cutting element that can cut the web to form an electrode. The electrode can be a singulated electrode or can be an electrode portion that is continuous or integrally formed with at least one adjacent electrode portion. The calendaring device or the calendar-laminator can be operatively coupled with the notching device such that the web can be provided from the calendaring device or the calendar-laminator to the notching device, for example.

At least one aspect is directed to a system. The system can include a calendaring device. The calendaring device can include a first roller and a second roller. The calendaring device can apply a force to a material between the first roller and the second roller to form a web. The system can include a notching device to cut the web to form an electrode. The web can be provided from the calendaring device to the notching device.

At least one aspect is directed to a method. The method can include applying a force, via a first roller and a second roller of a calendaring device, to a material to form a web. The method can include providing, from the calendaring device, the web to a notching device. The method can include cutting, via the notching device, the web to form an electrode.

At least one aspect is directed to an apparatus. The apparatus can be a battery electrode. The battery electrode can include a material adhered to a current collector material. The battery electrode can be produced by applying a force, via a first roller and a second roller of a calendaring device, the material to form a web. The battery electrode can be produced by providing, from the calendaring device, the web to a notching device. The battery electrode can be produced by cutting, via the notching device, the web to form an electrode.

At least one aspect is directed to a method. The method can include providing a system. The system can include a calendaring device including a first roller and a second roller. The calendaring device can apply a force to a material between the first roller and the second roller to form a web. The system can include notching device to cut the web. The web can be provided from the calendaring device to the notching device.

At least one aspect is directed to a method. The method can include providing a battery electrode. The battery electrode can be produced by applying a force, via a first roller and a second roller of a calendaring device, the material to form a web. The battery electrode can be produced by providing, from the calendaring device, the web to a notching device. The battery electrode can be produced by cutting, via the notching device, the web to form an electrode.

At least one aspect is directed to an electric vehicle. The electric vehicle can include a battery cell having a battery electrode. The battery electrode can include a material adhered to a current collector material. The battery electrode can be produced by applying a force, via a first roller and a second roller of a calendaring device, the material to form a web. The battery electrode can be produced by providing, from the calendaring device, the web to a notching device. The battery electrode can be produced by cutting, via the notching device, the web to form an electrode.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A depicts an example system for manufacturing a battery electrode, in accordance with some aspects.

FIG. 1B depicts an example system for manufacturing a battery electrode, in accordance with some aspects.

FIG. 1C depicts an example system for manufacturing a battery electrode, in accordance with some aspects.

FIG. 1D depicts an example system for manufacturing a battery electrode, in accordance with some aspects

FIG. 2A depicts an example system for manufacturing a battery electrode, in accordance with some aspects.

FIG. 2B depicts an example system for manufacturing a battery electrode, in accordance with some aspects.

FIG. 3A depicts an example battery electrode, in accordance with some aspects.

FIG. 3B depicts an example battery electrode, in accordance with some aspects.

FIG. 4A depicts an example system for manufacturing a battery electrode, in accordance with some aspects.

FIG. 4B depicts an example system for manufacturing a battery electrode, in accordance with some aspects.

FIG. 5 depicts an example system for manufacturing a battery electrode, in accordance with some aspects.

FIG. 6 depicts an example battery electrode, in accordance with some aspects.

FIG. 7 is a flow diagram of an example method of manufacturing a battery electrode, in accordance with some aspects.

FIG. 8 depicts an example electric vehicle, in accordance with some aspects.

FIG. 9 depicts an example battery pack, in accordance with some aspects.

FIG. 10 depicts an example battery module, in accordance with some aspects.

FIG. 11 depicts a cross sectional view of an example battery cell, in accordance with some aspects.

FIG. 12 depicts a cross sectional view of an example battery cell, in accordance with some aspects.

FIG. 13 depicts a cross sectional view of an example battery cell in accordance with some aspects.

FIG. 14 is a flow diagram of an example method of providing a system for manufacturing a battery electrode, in accordance with some aspects.

FIG. 15 is a flow diagram of an example method of providing a battery electrode, in accordance with some aspects.

### DETAILED DESCRIPTION

Following below are more detailed descriptions of various concepts related to, and implementations of, methods, apparatuses, and systems of battery electrode manufacturing. The various concepts introduced above and discussed in greater detail below may be implemented in any of numerous ways.

The present disclosure is directed to systems and methods of manufacturing a battery electrode. More particularly, the present disclosure is directed to systems and methods of manufacturing a battery electrode that include slitting or notching operations in-line with a calendaring operation. The systems and methods can produce a plurality of singulated battery electrodes (e.g., individual or separated), or a roll (e.g., continuous sheet or web) of notched battery electrodes. The systems and methods can produce a battery electrode for a battery cell.

The disclosed solutions have a technical advantage of combining multiple battery electrode manufacturing processes into a single system. For example, the disclosed solutions can combine two or more operations, for example the calendaring operation (or calendaring and laminating operation), the notching operation, and the slitting operation, into one system. This can reduce or eliminate a need to transport output from one system performing one operation to second system performing a second operation. The disclosed solutions can therefore increase processing speed and efficiency while reducing material waste. For example, the system can include a calendaring device (e.g., a calendar-laminator or a calendaring device) to provide a web of electrode material (e.g., a battery active material adhered to a current collector foil) directly or indirectly to a notching device. The calendaring device can provide the web directly to the notching device (e.g., with no intervening operations) or indirectly (e.g., with one or more intervening operations). The calendaring device can be operatively coupled with the notching device such that an output of the calendaring device can be provided to the notching device without intervention by an operator, transporting the output of the calendaring device to another system, or other disjunctive procedure.

Systems and methods of the present technical solution can include a calendaring device, a notching device, or a slitting device. The calendaring device can be a calendar-laminator device or a calendaring device. For example, the system can include a calendar-laminator that can create a film from battery active material (e.g., a dry powder, semi-dry mixture or other material) or laminate the film to at least one side of a current collector material. The calendar-laminator can produce a sheet (e.g., a web) of electrode material. The system can include a calendaring device in addition to or in place of the calendar-laminator. For example, the calendaring device can apply a force to a material (e.g., a film, a film laminated to a current collector material) to form a sheet of electrode material. The system can include a notching device that receives the sheet of electrode material from the calendaring device calendar laminator. For example, a conveyor substrate or other web guiding devices (e.g., a web handling device) could provide the sheet of electrode material to the notching device. The notching device can notch the sheet of electrode material to form at least one electrode tab. For example, the notching device can cut a current collector tab from the electrode sheet, where the current collector tab can include a portion of current collector material that is not laminated with a battery active material. The notching device can cut the sheet of electrode material to form a tab on a first side and a second side of the sheet. The system can include a slitting device. The slitting device can cut the notched electrode sheet between the tab on the first side and the tab on the second side. For example, the slitting device can cut the notched electrode sheet along a centerline between the first edge and the second edge.

The notching device and the slitting device can be combined. For example, a notching and slitting device could substantially simultaneously perform the notching operation and the slitting operation. The notching device can be or include a rotary die cutting element that includes a flexible knife sheet or blade wrapped around a roller. The knife sheet or blade can cut through the electrode sheet to notch the tab or slit the electrode sheet with the electrode sheet between the roller and a backing roller. For example, the knife sheet or blade can apply a pressure to cut the electrode sheet as the electrode sheet is fed between the roller and a backing roller to create a singulated electrode or at least one continuous electrode sheet. The notching device can include a laser cutting element. For example, the notching device can be or include a laser cutting element that can cut through the electrode sheet to notch the electrode sheet. The laser cutting element can include a first laser to notch the electrode sheet proximate to the first side of the sheet and a second laser to notch the electrode sheet proximate to the second side of the sheet. The laser cutting element can include a third laser to slit the electrode sheet. For example, the third laser can cut the electrode sheet along a centerline to cut the electrode sheet into two continuous rolls (e.g., sheets or webs). The laser cutting element can include a first laser element and a second laser element to notch the electrode sheet to form a tab, while a separate slitting device can be positioned downstream of the first and second laser cutting elements to slit the electrode sheet.

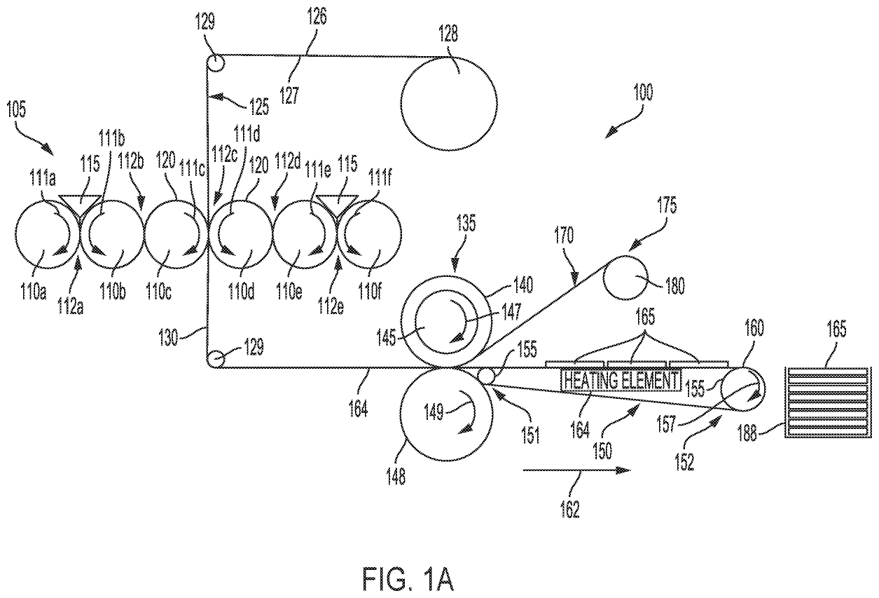

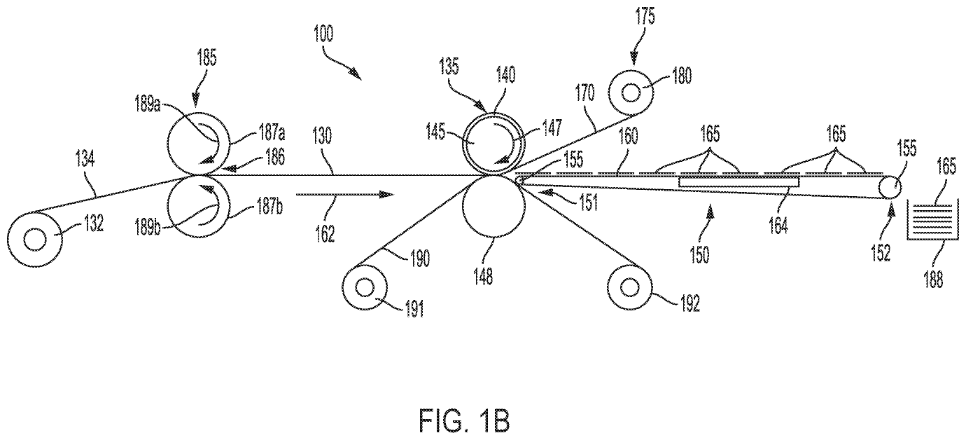

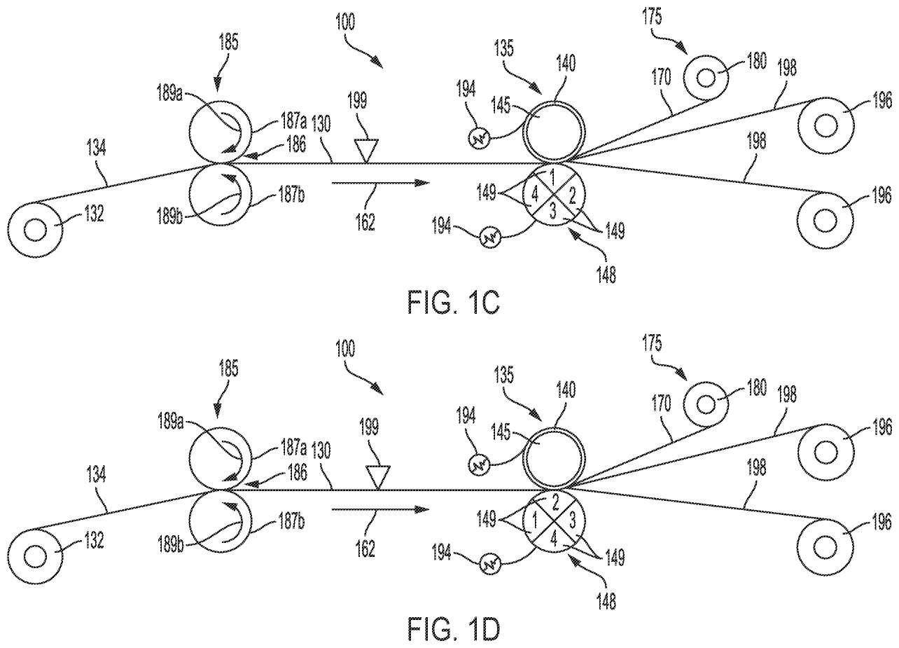

FIGS. 1A, 1B, 1C, 1D, 2A, 2B, 4A, 4B, and 5, among others, depict an example system 100 to manufacture an electrode. The system can produce an electrode for a battery. For example, the system 100 can produce an electrode for a rechargeable battery of an electric vehicle, such as an electric truck or electric sport utility vehicle (SUV). Among other examples, the system 100 can produce electrodes for a lithium ion (Li-ion) battery. The system 100 can produce a cathode electrode or an anode electrode that, when used in a battery, can receive electrical current or release electrons. In one example, the system 100 can receive a battery active material (e.g., dry or semi-dry powdered material or other material) and a current collector material as inputs. The at least one battery active material can be joined with (e.g., laminated with, chemically bonded with, fused with, adhered to) the current collector material. For example, the system 100 can produce an electrode including a first film joined with a first side of a current collector material and a second film joined with a second side of the current collector material. In other examples, the system 100 can receive another material, such as a web or electrode sheet as an input. The web or electrode sheet can include an electrode material laminated to a current collector material. The system 100 can produce at least one singulated (e.g., individual, cut, separated, single) electrode including a tab and an electrode body. The system 100 can produce at least one sheet (e.g., web or roll) of electrodes including at least one electrode portion having an electrode tab and an electrode body.

The system 100 can include at least one calendaring device. For example, the calendaring device can be a calendar-laminator 105 or the calendaring device 185. The system 100 can include the calendar-laminator 105. The calendar-laminator 105 can include at least one roller 110. For example, the calendar-laminator 105 can include rollers 110a, 110b, 110c, 110d, 110e, and 110f. Adjacent rollers can define a pressure point 112. For example, the roller 110a and the roller 110b can define a first pressure point 112a. The first pressure point 112a can be a gap (e.g., a space, a nip, an opening) between the roller 110a and the roller 110b where an outer surface of the roller 110a and an outer surface of the roller 110b are closest (e.g., where a distance between an outer surface of the roller 110a and an outer surface of the roller 110b is smallest). The outer surface of the rollers 110 can be smooth, textured, concave, convex, or rough. The outer surface of each of the rollers 110 can be the same as the other rollers 110. The outer surface of one or more of the rollers 110a-110f can be different than an outer surface of another roller 110a-110f. The rollers 110 can include a diameter. One or more of the rollers 110a-110f can include a first roller diameter. One or more of the rollers 110a-110f can include a second roller diameter, where the second roller diameter is different than the first roller diameter. At least one of the rollers 110 can be arranged horizontally, vertically, or at some other angle with respect to an adjacent roller 110. For example, the roller 110a can be oriented at an angle with respect to the roller 110b, while the roller 110c can be positioned horizontally relative to the roller 110b.

The rollers 110 can rotate about an axis in a direction 111. For example, the roller 110a can rotate about a first axis in a first direction 111a. The roller 110b can rotate about an axis in a second direction 111b. The first axis can be parallel with the second axis. The first direction 111a can be opposite the second direction 111b. The roller 110a can rotate about the first axis at a first speed to achieve a first angular velocity. The roller 110b can rotate about the second axis at a second speed to achieve a second angular velocity. The first speed can be different than the second speed. For example, the first speed can be greater than or less than the second speed. The first angular velocity can be different than the second angular velocity. For example, the first angular velocity can be greater than or less than the second angular velocity. The first angular velocity can be substantially similar to the second angular velocity (e.g., ±20%), for example.

The roller 110c can rotate about a third axis in a third direction 111c. The roller 110d can rotate about a fourth axis in a fourth direction 111d. The third axis can be parallel with the first axis, the second axis, and the fourth axis. One or more of the third axis or the fourth axis can be positioned within a different plane than the first axis or the second axis. The third direction 111c can be opposite the second direction 111b and opposite the fourth direction 111d. The roller 110c can rotate about the third axis at a third speed to achieve a third angular velocity. The roller 110d can rotate about the fourth axis at a fourth speed to achieve a fourth angular velocity. In some examples, the third speed can be the same as or substantially similar to (e.g., ±20%) the fourth speed. The third angular velocity can be the same as or substantially similar to the fourth angular velocity (e.g., ±20%), for example.

The roller 110e can rotate about a fifth axis in a fifth direction 111e. The roller 110f can rotate about a sixth axis in a sixth direction 111f. The fifth axis can be parallel with the first axis, the second axis, the third axis, the fourth axis, and the sixth axis. One or more of the fifth axis or the sixth axis can be positioned within a different plane than the first axis, the second axis, the third axis, or the fourth axis. The fifth direction 111e can be opposite the sixth direction 111f. The roller 110e can rotate about the fifth axis at a fifth speed to achieve a fifth angular velocity. The roller 110f can rotate about the sixth axis at a sixth speed to achieve a sixth angular velocity. In one example, the fifth speed can be different than the sixth speed. For example, the fifth speed can be greater than or less than the sixth speed. The fifth angular velocity can be different than the sixth angular velocity. For example, the fifth angular velocity can be greater than or less than the sixth angular velocity. The fifth angular velocity can be the same as or substantially similar to the sixth angular velocity (e.g., ±20%), for example.

The calendar-laminator 105 can include a first roller and a second roller to apply a force (e.g., a shearing force or a compressive force) to a material received between the first roller and the second roller to form a film 120. For example, the roller 110a can be the first roller. The roller 110b can be the second roller. The roller 110a and the roller 110b can rotate inwards towards the pressure point 112a to pull or draw a material into and through the pressure point 112a between the first roller 110a and the second roller 110b. The material can include a battery active material, such as lithium, nickel, manganese, or cobalt, among other materials. The material can be a powdered material, a dry mix, a semi-dry mix, or material in some other state.

The material can be provided to the roller 110a, the roller 110b, or other roller 110 via an infeed device 115. The infeed device 115 can be a hopper device configured to provide a predefined or controlled amount of a dry powdered battery active material at the pressure point 112a or the pressure point 112b, for example. The infeed device 115 can provide the material to a pressure point 112 formed by at least one of the roller 110a, the roller 110b, or the roller 110c, where the rotation of the first roller 110a, the roller 110b, or the roller 110c can cause the roller the material to be drawn through the pressure point 112a, the pressure point 112b, or some other pressure point. The infeed device 115 can provide the material to the pressure point 112a (e.g., to the roller 110a or the roller 110b) or to the pressure point 112b (e.g., to the roller 110b or the roller 110c) at a predefined rate such that an amount of material sheared through the pressure point 112a or the pressure point 112b remains substantially constant (e.g., ±10% variance). In one example, the infeed device 115 can include a reservoir or container configured to store material to be provided to the pressure point 112a or the pressure point 112b. The infeed device 115 can provide the material to another pressure point 112 or to one or more rollers 110 other than the roller 110a, the roller 110b, or the roller 110c.

As the material is drawn through the pressure point 112a, it can be compressed or sheared by the roller 110a and the roller 110b to form the film 120. The film 120 can be a film made of the material that is produced after the material is subject to compression forces between the first roller 110a and the second roller 110b at the pressure point 112a. The film 120 can include the material (e.g., dry-powdered or semi-dry mix of electrode material) and a second material (e.g., a catalyst, chemical agent, a bonding agent, or other additive). The roller 110a can rotate in the first direction 111a at the first speed and first angular velocity. The roller 110b can contra-rotate in the second direction 111b at the second speed and second angular velocity. The first speed or first angular velocity can be less than the second speed or second angular velocity, respectively. A difference in speed or angular velocity of the roller 110a and the roller 110b can create a shearing force that shears the material as it passes through the pressure point 112a. A compressive force can be applied to the roller 110a or the roller 110b to compress the material as it passes through the pressure point 112a. The film 120 can include a thickness that is proximate to a distance between the outer surface of the roller 110b and the outer surface of the roller 110c at the pressure point 112b. For example, the film 120 can include a thickness that is determined by a shear rate or a shear force resulting from a difference in the first speed of the first roller 110a and the second speed of the second roller 110b. The thickness of the film 120 can be determined by an amount of compressive force applied to the material as it passes through a pressure point, such as the first pressure point 112a.

The calendar-laminator 105 can include the roller 110b and the roller 110c to apply a force (e.g., a shearing force or a compressive force) to a material received between the roller 110b and the roller 110c to form the film 120. For example, rather than shearing or compressing the material between the roller 110a and the roller 110b, the calendar-laminator 105 can shear or compress the material between the roller 110b and the roller 110c. For example, the roller 110b and the roller 110c can rotate inwards towards the pressure point 112b to pull or draw the material into and through the pressure point 112b between the roller 110b and the roller 110c. As the material is drawn through the pressure point 112b, it can be compressed or sheared to form the film 120. The roller 110b can rotate in the second direction 111b at the second speed and second angular velocity, while the roller 110c can contra-rotate in the third direction 111c at the third speed and third angular velocity. The second speed or second angular velocity can be less than the third speed or third angular velocity, respectively. A difference in speed or angular velocity of the roller 110b and the roller 110c can create a shearing force that shears the material as it passes through the pressure point 112b. The film 120 created by a shearing operation between the roller 110a and the roller 110b can include a thickness that is proximate to a distance (e.g., a gap) between the outer surface of the roller 110b and the outer surface of the roller 110c at the pressure point 112b. For example, the film 120 can include a thickness that is determined by a shear rate or a shear force resulting from a difference in the second speed of the second roller 110b and the third speed of the third roller 110c. The thickness of the film 120 can be determined by an amount of compressive force applied to the material as it passes through a pressure point, such as the pressure point 112b.

The calendar-laminator 105 can include the roller 110e and the roller 110d to shear or compress a second material received between the roller 110e and the roller 110d to form a second film 120. For example, the calendar-laminator 105 can shear the material between the roller 110e and the roller 110d. The roller 110e and the roller 110d can rotate inwards towards the pressure point 112d to pull or draw the second material into and through the pressure point 112d between the roller 110e and the roller 110d. The second material can be or include a battery active material. The second material can be a powdered material, a dry mix, a semi-dry mix, or a liquid, or material in some other state. The second material can be the same as the material used to form the film 120 between the roller 110a and the roller 110b or between the roller 110b and the roller 110c.

The second material can be provided to the roller 110e, the roller 110f, the roller 110d or some other roller 110 via a second infeed device 115. The second infeed device 115 can be a hopper device configured to provide a predefined or controlled amount of a dry powdered battery active material at the pressure point 112d or the pressure point 112e, for example. The second infeed device 115 can provide the second material to a pressure point 112 formed by at least one of the roller 110f, the roller 110e, or the roller 110d, where the rotation of the roller 110f, the roller 110e, or the roller 110d can cause the second material to be drawn through the pressure point 112e or the pressure point 112d. The second infeed device 115 can provide the second material to the pressure point 112e (e.g., to the roller 110f or the roller 110e) or to the pressure point 112d (e.g., to the roller 110e or the roller 110d) at a predefined rate such that an amount of second material sheared through the pressure point 112e or the pressure point 112f can remain substantially constant (e.g., ±10% variance). In one example, the second infeed device 115 can include a reservoir or container configured to store second material to be provided to the pressure point 112e or the pressure point 112d. The second infeed device 115 can provide the material to another pressure point 112 or to one or more rollers 110 other than the roller 110f, the roller 110e, or the roller 110d.

As the second material is drawn through the pressure point 112e, it can be compressed or sheared to form the second film 120. The roller 110f can rotate in the sixth direction 111f at the sixth speed and sixth angular velocity. The roller 110e can contra-rotate in the fifth direction 111e at the fifth speed and fifth angular velocity. The sixth speed or sixth angular velocity can be less than the fifth speed or fifth angular velocity, respectively. A difference in speed or angular velocity of the roller 110f and the roller 110e can create a shearing force that shears the second material as it passes through the pressure point 112e. A compressive force can be applied to the roller 110e or the roller 110f to compress the material as it passes through the pressure point 112e. The second film 120 created by a shearing operation between the roller 110f and the roller 110e can include a thickness that is proximate to a distance between the outer surface of the roller 110e and the outer surface of the roller 110d at the pressure point 112d. For example, the second film 120 can include a thickness that is determined by a shear rate or a shear force resulting from a difference in the speed of the roller 110e and the speed of the roller 110f. The thickness of the second film 120 can be determined by an amount of compressive force applied to the material as it passes through a pressure point, such as the pressure point 112e.

The calendar-laminator 105 can include the roller 110e and the roller 110d to shear or compress the second material received between the roller 110e and the roller 110d to form the second film 120. For example, rather than shearing the second material between the roller 110f and the roller 110e, the calendar-laminator 105 can shear the second material between the roller 110f and the roller 110e. The roller 110e and the roller 110d can rotate inwards towards the pressure point 112d to pull or draw the material into and through the pressure point 112d between the roller 110e and the roller 110d. As the second material is drawn through the pressure point 112d, it can be compressed or sheared to form the second film 120. The roller 110e can rotate in the fifth direction 111e at the fifth speed and fifth angular velocity. The roller 110d can contra-rotate in the fourth direction 111d at the fourth speed and fourth angular velocity. The fifth speed or fifth angular velocity can be less than the fourth speed or fourth angular velocity, respectively. A difference in speed or angular velocity of the roller 110e and the roller 110d can create a shearing force that shears the material as it passes through the pressure point 112d. The second film 120 created by a shearing operation between the roller 110e and the roller 110d can include a thickness that is proximate to a distance between the outer surface of the roller 110e and the outer surface of the roller 110d at the pressure point 112d. For example, the second film 120 can include a thickness that is determined by a shear rate or a shear force resulting from a difference in the speed of the roller 110d and the speed of the roller 110e. The thickness of the second film 120 can be determined by an amount of compressive force applied to the material as it passes through a pressure point, such as the pressure point 112d.

The calendar-laminator 105 can include a third roller and a fourth roller to laminate the film 120 with a current collector material 125 to form a web 130. For example, the roller 110c can be the third roller and the roller 110d can be the fourth roller. The calendar-laminator 105 can include the roller 110c and the roller 110d to laminate the film 120 with the current collector material 125. The current collector material 125 can include a first side 126 and a second side 127. The roller 110c and the roller 110d can receive the film 120 at the pressure point 112c. The roller 110c and the roller 110d can receive the current collector material 125 at the pressure point 112c. The current collector material 125 can include a first side 126 and a second side 127. The current collector material 125 can be a thin film, such as a current collector foil, current collector substrate, current collector membrane, or other material. The current collector material 125 can be provided to the pressure point 112c via at least one web handling device 129. For example, the web handling device 129 can include one or more bearings that can allow the web handling device 129 to roll or spin as the current collector material 125 is provided to the pressure point 112c.

The web handling device 129 can provide the current collector material 125 to the roller 110c and the roller 110d. For example, the current collector material 125 can be provided between the roller 110c and the roller 110d at the pressure point 112c. The current collector material 125 can be provided to calendar-laminator 105 in a rolled form. For example, a roll 128 of current collector material 125 can be unrolled to provide a sheet (e.g., layer or web) of current collector material 125 to the pressure point 112c. The unrolled current collector material 125 can be a film that is directed to the pressure point 112c via at least one web handling device 129. The web handling device 129 can include one or more bearings that can allow the web handling device 129 to roll or spin as the current collector material 125 is provided to or drawn from (when laminated with a battery active material, for example) the pressure point 112c. The web handling device 129 can include a rubberized or gripped surface or texture that can prevent the current collector material 125 from slipping or moving with respect to the web handling device 129 other than in the direction of rotation of the web handling device 129 (e.g., towards the pressure point 112c). The web handling device 129 can act to apply a tension to the current collector material 125 such that the current collector material 125 can be taut or without slack as it passes through the pressure point 112c, for example.

The roller 110c and the roller 110d can receive the film 120 and the current collector material 125 at the pressure point 112c. For example, the roller 110c and the roller 110d can rotate inwards towards the pressure point 112c to pull or draw the film 120 and the current collector material 125 into and through the pressure point 112c between the roller 110c and the roller 110d. As the film 120 and the current collector material 125 are drawn through the pressure point 112c, the film 120 can be laminated with the first side 126 of the current collector material 125 to form the web 130. The web 130 can include the film 120 laminated with at least one side 126, 127 of the current collector material 125. For example, the web 130 can be or include an electrode sheet (e.g., web or layer) including a layer of battery active material (e.g., the film 120) bonded with at least one side of the current collector material 125. When laminated, the current collector material 125 and the film 120 can be joined such that the film 120 cannot easily be separated from the current collector material 125 (e.g., without use of substantial force). The film 120 can be joined to the current collector via an adhesive, application of heat, or some other joining method, for example.

The calendar-laminator 105 can include a third roller and a fourth roller to laminate the film 120 and the second film 120 with the current collector material 125 to form the web 130. The calendar-laminator 105 can include the roller 110c and the roller 110d to laminate the film 120 with the first side 126 of the current collector material 125. The calendar-laminator 105 can include the roller 110c and the roller 110d to laminate the second film 120 with the second side 127 of the current collector material 125. The roller 110c and the roller 110d can receive the film 120 at the pressure point 112c, where the film 120 was compressed or sheared by roller 110a, the roller 110b, or the roller 110c. The roller 110c and the roller 110d can receive the second film 120 at the pressure point 112c, where the second film 120 was compressed or sheared by the roller 110f, the roller 110e, or the roller 110d. The roller 110c and the roller 110d can receive the current collector material 125 at the pressure point 112c. The current collector material 125 can be a thin film, such as a current collector foil, current collector substrate, current collector membrane, or other material. The current collector material 125 can be provided to the pressure point 112c via at least one web handling device 129. For example, the web handling device 129 can include one or more bearings that can allow the web handling device 129 to roll or spin as the current collector material 125 is provided to the pressure point 112c.

The roller 110c and the roller 110d, or the pressure point 112c, can receive the film 120, the second film 120, and the current collector material 125 at the pressure point 112c. For example, the roller 110c and the roller 110d can rotate inwards towards the pressure point 112c to pull or draw the film 120, the second film 120, and the current collector material 125 into and through the pressure point 112c between the roller 110c and the roller 110d. The film 120 can be adjacent to the first side 126 of the current collector material 125. The second film 120 can be adjacent to the second side 127 of the current collector material 125. As the film 120, the second film 120, and the current collector material 125 are drawn through the pressure point 112c, the film 120 can be laminated with the first side 126 of the current collector material 125 to form the web 130. As the film 120, the second film 120, and the current collector material 125 are drawn through the pressure point 112c, the second film 120 can be laminated with the second side 127 of the current collector material 125 to form the web 130. For example, the web 130 can include the film 120 laminated with the first side 126 of the current collector material 125 and the second film 120 laminated with the second side 127 of the current collector material 125. For example, the web 130 can be or include an electrode sheet (e.g., web or layer) including a first layer of battery active material (e.g., the film 120) bonded with the first side 126 of the current collector material 125 and a second layer of battery active material (e.g., the second film 120) bonded with the second side 127 of the current collector material 125. When laminated, the current collector material 125 and the film 120 can be joined such that the film 120 cannot easily be separated from the current collector material 125 (e.g., without use of substantial force). The second film 120 and the current collector material 125 can be joined such that the second film 120 cannot easily be separated from the current collector material 125 (e.g., without use of substantial force).

The system 100 can include at least one calendaring device. For example, calendaring device can be the calendaring device 185 to apply a force (e.g., a compressive force, a calendaring force) to a web 134. The calendaring device 185 can calendar the web 134 to form the web 130. Forming the web can include compacting, compressing, pressing, or shearing a material to a particular density, thickness, or other parameter. The web 134 can be provided to the system 100 in a rolled form via a roll 132. The film 134 can be unwound from the roll 132 and provided to the calendaring device 185. The web 134 can include an electrode material (e.g., a cathodic or anodic battery active material) that is laminated to at least one side of a current collector material (e.g., a copper or aluminum foil). For example, the web 134 can be a battery electrode sheet, layer, or web. The web 134 can be produced by, for example, a calendar-laminator device (e.g., the calendar-laminator 105), where the calendar-laminator is located remotely from the system 100. The web 134 can also be produced by applying a wet or semi-wet electrode material to a current collector material using a slot-die coating system or other device. The system 100 can receive the web 134 rather than create a web of battery electrode material via a calendar-laminator device (e.g., the calendar-laminator 105). For example, rather than laminating a film (e.g., the film 120) to a foil (e.g., the current collector material 125) to produce a web 130, the system 100 can receive the web 134. The system 100 can include the calendaring device 185 independent of a calendar-laminator device (e.g., the calendar-laminator 105 as depicted in FIG. 1, among others).

The calendaring device 185 can include a first roller 187a and a second roller 187b. The first roller 187a and the second roller 187b define a first pressure point 186. The first pressure point 186 can be a gap (e.g., a space, a nip, an opening) between the first roller 187a and the second roller 187b where an outer surface of the roller 187a and an outer surface of the roller 187b are closest (e.g., where a distance between an outer surface of the roller 187a and an outer surface of the roller 187b is smallest). The outer surface of the first roller 187a and the second roller 187b can be smooth, textured, concave, convex, or rough. The outer surface of the first roller 187a can be the same as or different than the outer surface of the second roller 187b. The first roller 187a and the second roller 187b can include a diameter. The diameter of the first roller 187a can be the same as or different than the diameter of the second roller 187b. The first roller 187a can be arranged vertically from (e.g., above or below) the second roller 187b. The first roller 187a can be arranged horizontally from (e.g., to the right or left of) the second roller 187b. The first roller 187a can be otherwise arranged with respect to the second roller 187b (e.g., at an angle with respect to the second roller 187b).

The first roller 187a can rotate about an axis in a direction 189a and the second roller 187b can rotate about an axis in a direction 189b. The axis about which the first roller 187a rotates can be parallel with the axis about which the second roller 187b rotates. The first direction 189a can be opposite the second direction 189b. The roller 187a can rotate about an axis at a first speed to achieve a first angular velocity. The roller 187b can rotate about an axis at a second speed to achieve a second angular velocity. The first speed can be different than the second speed. The first speed can be the same as or substantially similar to (e.g., ±98% similar to) the second speed. The first angular velocity can be different than the second angular velocity. The first angular velocity can be the same as or substantially similar to (e.g., ±98% similar to) the second angular velocity.

The system 100 can include the calendaring device 185 to calendar the web 130 between the first roller 187a and the second roller 187b. For example, the web 134 can be positioned between the first roller 187a and the second roller 187b. The web 134 can pass through the pressure point 186 formed by the first roller 187a and the second roller 187b. The first roller 187a or the second roller 187b can impart a compressive force (e.g., a calendaring force) on the web 134 as the web 134 passes between the first roller 187a and the second roller 187b through the pressure point 186. For example, the web 134 can undergo a calendaring operation at the pressure point 186. The calendaring operation can affect a thickness or a density of the web 134. For example, the calendaring operation performed by the calendaring device 185 can decrease a thickness of the web 134 as the web 134 passes through the pressure point 186. The calendaring device 185 can increase a density of the web 134 as the web 134 passes through the pressure point 186 by applying a compressive force to the web 134. The web 130 can be the web 134 after the web 134 has been calendared by the calendaring device 185.

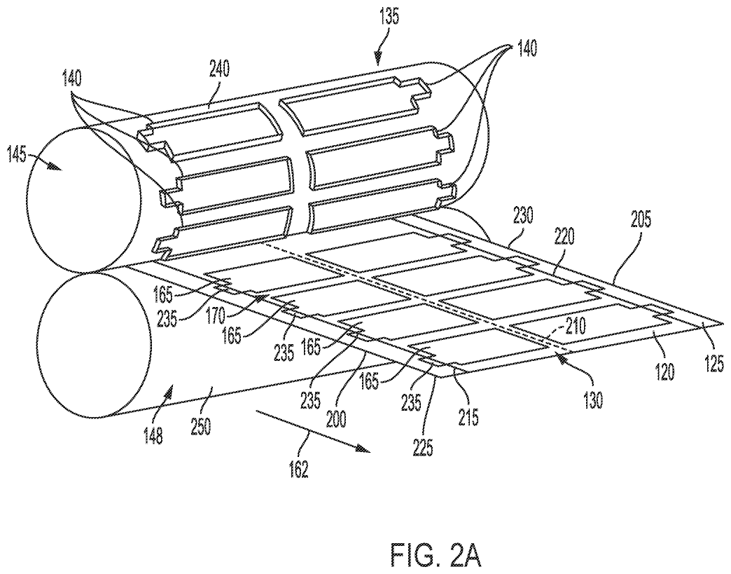

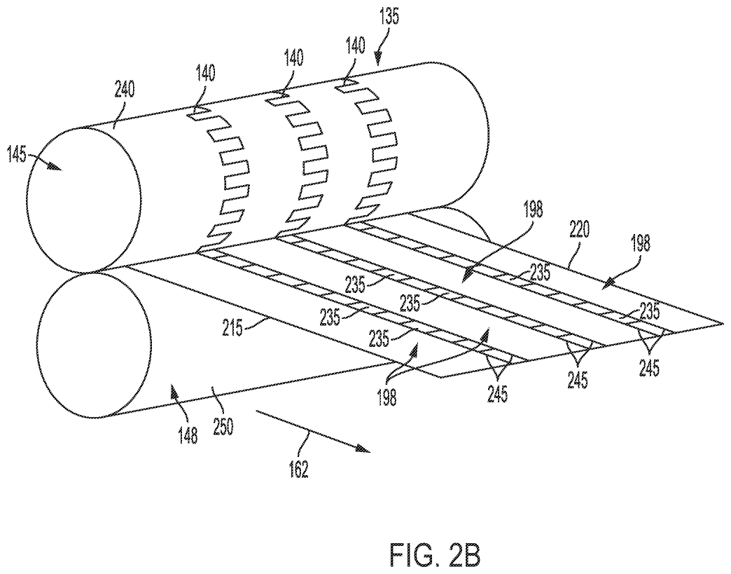

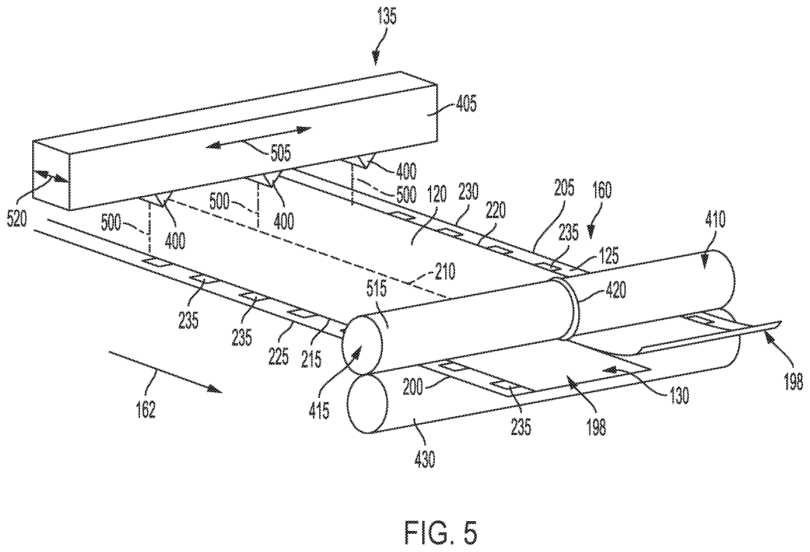

A portion of the current collector material 125 can be exposed with the film 120 and the second film 120 laminated with the current collector material 125. For example, the film 120 and the second film 120 can include a width. The width of the film 120 can be substantially similar to (e.g., ±10%) to the width of the second film 120. The current collector material 125 can include a width that is slightly greater than (e.g., 5-20% greater) than the width of the film 120 or the second film 120. As shown in FIGS. 2A, 2B, and 5, among others, the film 120 can include a centerline 210 that is positioned between a first edge 215 and a second edge 220 of the film 120. The second film 120 can include a centerline that is positioned between a first edge and a second edge of the second film 120. The current collector material 125 can include a centerline that is positioned between a first edge 225 and a second edge 230 of the current collector material 125. The calendar-laminator 105 can laminate the film 120 and the second film 120 to the current collector material 125 such that the centerline 210 of the film 120, the centerline of the second film 120, and the centerline of the current collector material 125 are substantially aligned (e.g., with less than 5% positional variance). With the centerlines substantially aligned, a portion of the current collector material 125 may be exposed on either side of the film 120 and the second film 120. As shown in FIGS. 2A and 5, among others, a distance (e.g., 0.5-2 inches, 1-5 centimeters, less than 1 cm, or some other distance) may exist between the first edge 225 of the current collector material 125 and the first edge 215 of the film 120. A distance (e.g., 0.5-2 inches, 1-5 centimeters) may exist between the first edge 225 of the current collector material 125 and the first edge of the second film 120. A distance (e.g., 0.5-2 inches, 1-5 centimeters) may exist between the second edge 230 of the current collector material 125 and the second edge 220 of the film 120. A distance (e.g., 0.5-2 inches, 1-5 centimeters) may exist between the second edge 230 of the current collector material 125 and the second edge of the second film 120. In other examples, an edge 215, 220 of the film 120 can be aligned with an edge 225, 230 of the current collector material 125 such that a portion of the current collector material 125 is exposed only on one side of the film 120. In yet other examples, the distance between the first edge 225 of the current collector material 125 and the first edge 215 of the film 120 can be different than a distance between the second edge 230 of the current collector material 125 and the second edge 220 of the film 120.

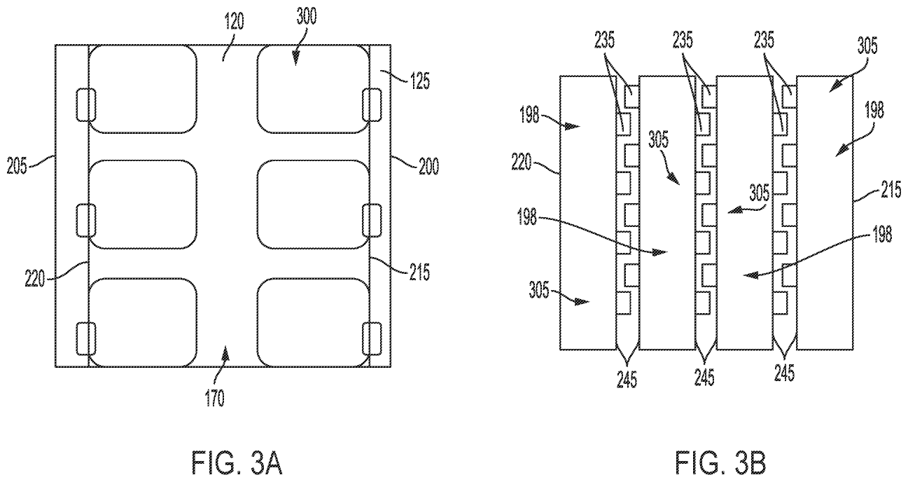

As shown in FIGS. 2B and 3B, among others, the web 130 can include the first edge 215, the second edge 220, and two or more intermediate edges 245. For example, the web 130 can include a plurality of films 120 laminated to a first side of the current collector material 125 and a plurality of films 120 laminated to a second side of the current collector material 125, where each film 120 is spaced apart from and extends parallel to an adjacent film 120. Each of the intermediate edges 245 can be a boundary of the film 120 on the current collector material 125, where the current collector material 125 extends between the film 120 and an adjacent film 120. For example, the web 130 can include a first film 120, a second film 120, a third film 120, and a fourth film 120. The first film 120 can include the first edge 215 and an intermediate edge 245. The second film 120 can be spaced apart from the first film 120. The second film 120 can include two intermediate edges 245. A portion of the current collector material 125 can separate the intermediate edge 245 of the first film 120 from an intermediate edge 245 of the second film 120. The third film 120 can include two intermediate edges 245. A portion of the current collector material 125 can separate an intermediate edge 245 of the second film 120 from an intermediate edge 245 of the third film 120. The fourth film 120 can include an intermediate edge 245 and the second edge 220. A portion of the current collector material 125 can separate an intermediate edge 245 of the third film from the intermediate edge 245 of the fourth film. Each of the films 120 can be separated from an adjacent film 120 by some distance (e.g., 0.5-2 inches, 1-5 centimeters, greater than 2 inches, greater than 2 centimeters). The current collector material 125 between adjacent films 120 can be uncoated current collector material 125 (e.g., current collector material 125 that is not coated with an electrode material, battery active material, or otherwise).

The system 100 can include a notching device 135 to cut the web 130. For example, the system 100 can include the notching device 135 to cut the web 130 to form at least one electrode. The system 100 can include the notching device 135 to cut the web to form a singulated (e.g., individual, cut, separated, single) electrode 165. The notching device 135 can cut the web 130 to form multiple singulated electrodes 165. Each of the multiple singulated electrodes 130 can be substantially identical (e.g., greater than 95% identical) to each other. The notching device 135 can receive the web 130 as input and can provide multiple singulated electrodes 165 as output. Each of the singulated electrodes 165 can include a tab 235. For example, the electrode tab 235 can be a portion of the current collector material 125 that is not joined with the film 120 or the second film 120 and is thus exposed. The tab 235 can extend from the singulated electrode 165. The notching device 135 can include a blade (e.g., a blade 140) to cut the web 130 to form the singulated electrode 165. The notching device 135 can include some other cutting element (e.g., laser cutter, water jet, rotating blade, oscillating blade, or other device configured to cut through the web 130) to form the singulated electrode 165.

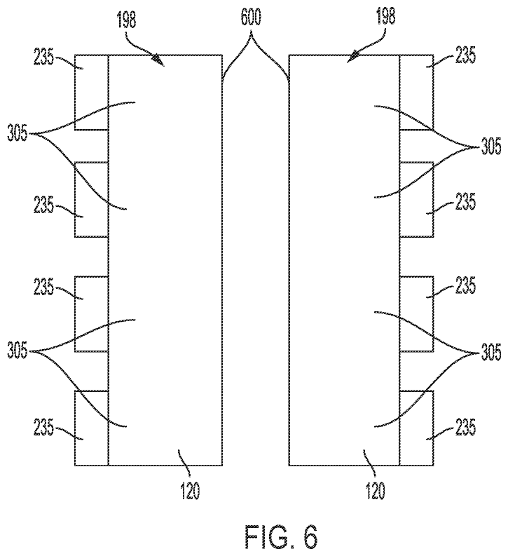

As shown in FIGS. 2B, 3B, 4A, 4B, 5, and 6, among others, the notching device 135 can cut the web 130 to form at least one electrode, such as an electrode portion 305. For example, rather than cutting a singulated electrode 165 from the web 130, thereby separating the electrode 165 from the web 130, the notching device 135 can notch or cut the web 130 to create multiple electrode portions 305, where each of the electrode portions 305 remains connected to at least one adjacent electrode portion 305. The multiple electrode portions 305 can include a tab 235. The tab 235 can be an electrode tab that extends from each electrode portion 305. The tab 235 can be or include a portion of the current collector material 125 that is exposed. For example, the tab 235 can include a portion of the current collector material 125 that is not joined with (e.g., bonded with, laminated with, adhered to) the film 120 or the second film 120. The notching device 135 can cut the tab 235 from the web 130 for each electrode portion 305, as shown in FIGS. 2B and 3B. The notching device 135 can include a blade (e.g., a blade 140) to cut the web 130 to form the electrode portion 305. The notching device 135 can include some other cutting element (e.g., laser cutter, water jet, rotating blade, oscillating blade, or other device configured to cut through the web 130) to form the electrode portion 305.

The system 100 can include the calendar-laminator 105 or the calendaring device 185 to provide the web 130 to the notching device 135. The system can included providing, from the calendaring device (e.g., the calendar-laminator 105 or the calendaring device 185), the web 130 to the notching device 135. For example, the calendar-laminator 105 can create the web 130 by laminating the film 120 or the second film 120 with the current collector material 125. The web 130 can be drawn from the pressure point 112c. In examples where a calendaring device 185 is used (in addition to or instead of a calendar-laminator 105), the web 130 can be drawn from the pressure point 186. At least one web handling device 129 can facilitate the movement of the web 130 from the pressure point 112c or the pressure point 186 and away from the calendar-laminator 105 or the calendaring device 185, respectively. For example, a web handling device 129 can be positioned beneath the pressure point 112c of the calendar-laminator 105 and can pull the web 130 downwards from the pressure point 112c in a substantially vertical direction (e.g., ±30 degrees from vertical). The web 130 can rotate partially around at least one web handling device 129 to change the direction of the movement of the web 130 after the web 130 has been drawn from the calendar-laminator 105. For example, the web 130 can be redirected by at least one web handling device 129. A web handling device 129 can alter the direction of movement of the web 130 such that the web 130 travels in a substantially horizontal direction (e.g., ±30 degrees from horizontal) after the web 130 rotates partially around the web handling device 129. In some examples, the web 130 can be pulled away from the calendar-laminator 105 or the calendaring device 185 via a winding device 196 or some other tensioning device. For example, the winding device 196 can wind a notched web 198, as is described in detail below, which can apply a tension to the web 130 and can draw the web 130 from the pressure point 112c or 188.

The web 130 can be provided by the calendar-laminator 105 or the calendaring device 185 to the notching device 135 via at least one web handling device 129. The notching device 135 can be horizontally disposed from the pressure point 112c or the pressure point 186. For example, the notching device 135 can be positioned some distance away from the pressure point 112c or the pressure point 186 such that the web 130 cannot be provided from the calendar-laminator 105 or the calendaring device 185 to the notching device 135 without some horizontal movement of the web 130 with respect to the pressure point 112c or pressure point 186. For example, the web handling device 129 can cause the web 130 to move in a substantially horizontal direction (e.g., ±30 degrees from vertical) to the notching device 135. The notching device 135 can receive the web 130 from the calendar-laminator 105 or the calendaring device 185 via the web handling device 129. The notching device 135 can cut the web 130 to form a singulated electrode 165 or an electrode portion 305. The notching device 135 can be positioned directly underneath the pressure point 112c or the pressure point 186 such that the web 130 can be provided to the notching device 135 without any horizontal movement of the web 130 relative to the pressure point 112c or the pressure point 186. For example, at least one web handling device 129 can be positioned beneath the pressure point 112c or the pressure point 186 to apply a tensioning force to the web 130 (e.g., to make the web 130 taut or remove any slack from the web 130) before the web 130 is provided to the notching device 135.

As shown in FIGS. 1-2, among others, the system 100 can include the notching device 135 including at least one blade 140 and at least one roller 145. For example, the notching device 135 can include a blade 140 coupled with a roller 145. The roller 145 can rotate about an axis in the direction 147. The roller 145 can include an outer surface 240. The outer surface 240 can be positioned proximate to the web 130. The blade 140 can be a coupled with the outer surface 240 of the roller 145. For example, the blade 140 can be a flexible blade that can match the curvature of the roller 145. The blade 140 can extend perpendicular to the outer surface 240 of the roller 145. A distal end of the blade 140 (e.g., the end extending away from the outer surface 240 of the roller 145) can be sharp such that blade can cut through the web 130 or other material. The blade 140 can cut the web 130 as the roller 145 rotates. For example, as the roller 145 rotates about the axis, the blade 140 can contact the web 130 to cut the web 130. The rotation of the roller 145 can cause the blade 140 to contact the web 130 with force (e.g., pressure against the web 130) such that the blade 140 cuts through the web 130. For example, the blade 140 can contact the web 130 with sufficient force that the blade 140 can cut through the film 120, the current collector material 125, and the second film 120.

The system 100 can include the notching device 135 including a blade 140 to cut the web 130 to form at least one tab 235. For example, the blade 140 can cut the web 130 to form an electrode tab 235 with each singulated electrode. Each of the singulated electrodes 165 can include a tab 235. For example, the electrode tab 235 can be a portion of the current collector material 125 that is not joined with the film 120 or the second film 120. For example, the current collector material 125 can include a first edge 225 that extends beyond the first edge 215 of the film 120 or the second edge of the second film 120 that are laminated with the current collector material 125. The current collector material 125 can include a second edge 230 that extends beyond the second edge 220 of the film 120 or the second edge of the second film 120 that are laminated with the current collector material 125. The tab 235 can be a portion of the current collector material 125 that extends beyond the first edge 215 or the second edge 220 of the film 120 or beyond the first edge or second edge of the second film 120. The singulated electrode 165 can include a tab 235 comprising current collector material 125 that extends beyond the first edge 215 or the second edge 220 of the film 120 or beyond the first edge or second edge of the second film 120. The tab 235 can extend from the singulated electrode 165 proximate a first edge 200 or a second edge 205 of the web 130, for example. The tab 235 can be integrally formed with the current collector material 125, and thus integrally formed with the singulated electrode 165. The tab 235 can be coupled with the singulated electrode 165.

The system 100 can include the notching device 135 including a first blade 140 and a second blade 140 coupled with the roller 145, the first blade 140 to cut the web 130 to form at least one first tab 235 proximate the first edge 200 of the web 130 and the second blade 140 to cut the web 130 to form at least one second tab 235 proximate the second edge 205 of the web 130 as the roller 145 rotates. For example, the notching device 135 can include multiple blades that each cut a singulated electrode 165 from the web 130 as the roller rotates. The notching device 135 can include multiple first blades 140 positioned radially around the outer surface 240 of the roller 145 to cut the web 130 to form singulated electrodes 165 that each have a tab 235 that is positioned proximate the first edge 200 of the web 130. The first blades 140 can be spaced apart along the outer surface 240 of the roller 145 such that each of the singulated electrodes 165 that are formed as the roller 145 rotates can be spaced apart. For example, the singulated electrodes 165 formed by the first blades 140 can be positioned close to each other in order to minimize waste, while also being sufficiently spaced apart to allow each singulated electrode 165 to be separately retrieved or handled in subsequent operations. The notching device 135 can include multiple second blades 140 positioned radially around the outer surface 240 of the roller 145 to cut the web 130 to form singulated electrodes 165 that each have a tab 235 that is positioned proximate the second edge 205 of the web 130. The second blades 140 can be spaced apart along the outer surface 240 of the roller 145 such that each of the singulated electrodes 165 that are formed as the roller 145 rotates can be spaced apart. For example, the singulated electrodes 165 formed by the second blades 140 can be positioned close to each other in order to minimize waste, while also being sufficiently spaced apart to allow each singulated electrode 165 to be separately retrieved or handled in subsequent operations.

The system 100 can include the notching device 135 to cut the web 130 with the web 130 supported on a backing roller 148. For example, the system 100 can include the notching device 135 including the blade 140 to cut the web 130 between the roller 145 and the backing roller 148. The backing roller 148 can be positioned beneath (e.g., vertically disposed below) the roller 145, above (e.g., vertically disposed above) the roller 145, to a side (e.g., horizontally disposed to the right or left of) the roller 145, or otherwise positioned relative to the roller 145. For example, the backing roller 148 can be directly adjacent to or offset from the roller 145. The backing roller 148 can be spaced apart from the roller 145 such that a gap exists between the outer surface 240 of the roller 145 and an outer surface 250 of the backing roller 148. For example, the backing roller 148 can support (e.g., carry, hold) the web 130 as the web 130 is cut by the notching device 135. The notching device 135 can cut the web 130 with the web 130 between the notching device 135 and the backing roller 148 to form at least one singulated electrode 165 or at least one electrode portion 305. For example, the notching device 135 may apply a pressure to an outer surface 250 of the backing roller 148 to cut the web 130. The blade 140 of the notching device 135 can apply a force normal to the outer surface 250 of the backing roller 148 to cut the web 130. For example, the distal end of the blade 140 can contact the web 130 with the web 130 supported by the backing roller 148. The blade 140 can contact a first side of the web 130 (e.g., a side that is closest to the notching device 135) and the backing roller 148 can contact a second side of the web 130 (e.g., a side that is farther from the notching device 135 than the first side). The backing roller 148 can prevent the web 130 from deflecting or moving away from the notching device 135 as the blade 140 contacts the web 130. For example, the backing roller 148 can support the web 130 to substantially prevent (e.g., prevent ±99% of) a deflection of the web 130 as the blade 140 contacts the web 130. The force of the blade 140 can be applied to the web 130 to cut the web 130 and to form the singulated electrode 165, for example.

The backing roller 148 can have a diameter that is similar to (e.g., ±10% different in diameter relative to) a diameter of the roller 145. The backing roller 148 can have a diameter that is larger than or smaller than a diameter of the roller 145. The backing roller 148 can be positioned proximate to the roller 145 of the notching device 135 such that an outer surface 240 of the roller 145 is proximate to (e.g., within two inches) of the outer surface 250 of the backing roller 148. For example, the backing roller 148 can be positioned such that the distal end of the blade 140 contacts the backing roller 148 as the roller 145 rotates. A position of the backing roller 148 with respect to the roller 145 or the blade 140 can be adjusted (e.g., altered, moved, changed). For example, the backing roller 148 can be moved closer to the roller 145 to account for wear in the blade 140 that may occur over time or with use of the blade 140. A distance between the outer surface 250 of the backing roller 148 and the outer surface 240 of the roller 145 can be reduced over time such that the distal end of the blade 140 contacts the outer surface 250 of the backing roller 148 even as the blade 140 wears (e.g., a length of the blade is reduced). Contact between the blade 140 and the backing roller 148 can impart a force on the outer surface 250 of the backing roller 148 that can cause the backing roller 148 to wear or be damaged. The backing roller 148 can be or include a resilient or wear-resistant material to mitigate wear or damage to the backing roller 148. For example, the outer surface 250 of the backing roller 148 can include a wear-resistant material that can resist or wear, damage, blemishes, or impressions that can result by a force imparted by the blade 140 as the blade 140 cuts the web 130 to form the singulated electrode 165.

As depicted in FIGS. 1A and 1B, among others, the system 100 can include a conveyor device 150. The conveyor device 150 can include at least one roller 155 and at least one conveyor substrate 160. For example, the conveyor device 150 can include a conveyor substrate 160 that is operatively coupled with the roller 155. The roller 155 can rotate about an axis. A rotation of the roller 155 can cause the conveyor substrate 160 move. For example, as the roller 155 rotates, an outer surface of the roller 155 can interact with the conveyor substrate 160 to cause the conveyor substrate 160 to move in a direction of rotation of the roller 155. The conveyor device 150 can include two or more rollers 155. For example, the conveyor substrate 160 can be a continuous (e.g., looped, banded) substrate that interacts with at least two rollers 155. One roller 155 can be proximate a first end 151 of the conveyor device 150, and one roller 155 can be proximate a second end 152 of the conveyor device 150. The conveyor substrate 160 can be under tension with the conveyor substrate 160 wrapped around the two or more rollers 155. For example, the conveyor substrate 160 may be taut or without slack in for a length between the first roller 155 and the second roller 155. The notching device 135 can be positioned proximate to (e.g., within one inch of, within one foot of, within two feet of, or within some other distance of) the first end 151 of the conveyor device 150. The conveyor device 150 can extend away from the notching device 135 in a first direction 162 such that the second end 152 can be positioned away from (e.g., two feet from, four feet from, more than four feet from) the notching device 135.

The system 100 can include the conveyor substrate 160 to provide a singulated electrode 165 to a magazine 188. For example, the conveyor substrate 160 can be substantially straight or flat (e.g., ±5% straightness or flatness variation) between the first roller 155 and the second roller 155. The first roller 155 proximate the first end 151 of the conveyor device 150 can be positioned horizontally from the second roller 155 proximate the second end 152 of the conveyor device 150. The first roller 155 can have a diameter that is substantially equal to (e.g., ±5%) a diameter of the second roller 155 or the first roller 155 can have a diameter that is greater than or less than a diameter of the second roller 155. At least a portion of the conveyor substrate 160 can extend in a horizontal direction between the first roller 155 and the second roller 155, where the horizontal portion of the conveyor substrate 160 is substantially flat (e.g., greater than 95% of the portion of the conveyor substrate 160 is flat). The portion of the conveyor substrate 160 extending between the first roller 155 and the second roller 155 can be tensioned (e.g., taut, without slack) such that the conveyor substrate 160 does not deflect or deflects only a minor amount (e.g., 0.5-10% deflection) when subjected to a force that is normal to the conveyor substrate 160. The first roller 155 can be positioned at an angle or vertically from the second roller 155. For example, the conveyor substrate 160 can extend at an angle between the first roller 155 and the second roller 155. The conveyor substrate 160 can extend vertically between the first roller 155 and the second roller 155. For example, the conveyor substrate 160 can extend away from the notching device 135 in a direction having a first component in the first direction 162 and a second component in an upwards or downwards direction relative to the first direction 162.

The system 100 can include the conveyor device 150 including a roller 155, where a rotation of the roller 155 causes the at least a portion of the conveyor substrate 160 to move in the first direction 162. For example, the conveyor substrate 160 can extend in a substantially straight or flat (e.g., ±5% straightness or flatness variation) between the first roller 155 and the second roller 155 of the conveyor device 150. As the first roller 155 or the second roller 155 rotate, the conveyor substrate 160 can move. For example, if the first roller 155 rotates in a direction 157 or the second roller 155 rotates in the direction 157, the conveyor substrate 160 can move in the first direction 162.

The conveyor device 150 can receive at least one singulated electrode 165 from the notching device 135. For example, singulated electrodes 165 that have been notched by the notching device 135 can exit the notching device 135 and be received on the conveyor substrate 160. For example, the conveyor substrate 160 can receive the singulated electrode with the first roller 155 of the conveyor device 150 positioned proximate to (e.g., within one inch of, within one foot of, within two feet of, or within some other distance of) the notching device 135. The conveyor substrate 160 can move in the first direction 162 away from the notching device 135 towards the magazine 188. For example, the conveyor substrate 160 can move in the first direction 162 to move the singulated electrode in the first direction 162 away from the notching device 135 to the magazine 188.

The system 100 can include the magazine 188 to receive at least one singulated electrode 165. For example, the magazine 188 can define an opening or cavity that can receive a singulated electrode 165. The magazine 188 can be positioned proximate to (e.g., within one inch of, within one foot of, within two feet of, or within some other distance of) the second end 152 of the conveyor device 150. For example, the magazine 188 can be positioned proximate to (e.g., within one inch of, within one foot of, within two feet of, or within some other distance of) the second roller 155 of the conveyor device 150 such that an object (e.g., a singulated electrode 165) can be received by (e.g., fall into, descend towards) the magazine 188 as the conveyor substrate 160 moves the object in the first direction 162 past the second roller 155 and off of the conveyor device 150. The magazine 188 can receive multiple singulated electrodes 165. For example, the notching device 135 can notch the web 130 to create multiple singulated electrodes 165. Each of the singulated electrodes 165 can be received by the conveyor substrate 160 as they exit the notching device 135. The conveyor device 150 can move the conveyor substrate 160 in the first direction 162 to move the received singulated electrodes 165 in the first direction 162. The conveyor device 150 can move the received singulated electrodes 165 in the first direction 162 off of the second end 152 of the conveyor device 150. The magazine 188 can receive (e.g., catch, capture, retain) the singulated electrodes 165 as they exit the conveyor substrate 160 of the conveyor device 150.

The system 100 can include the conveyor device 150 to provide heat to the singulated electrode 165. For example the conveyor device 150 can include the conveyor substrate 160 at an elevated temperature to warm, heat, dry, or cure the singulated electrode 165. The conveyor device 150 can include a heating element 164. The heating element 164 can emit heat or heating energy. For example, the heating element can be a ceramic heating element, and resistive heating element, an infrared heating element, fluid-based heating element (e.g., a boiler) that can produce or emit heating energy a surrounding environment. The heating element 164 can be positioned relative to the conveyor device 150 such that the conveyor substrate 160, the first roller 155, the second roller 155, or the air surrounding the conveyor substrate 160, first roller 155, or second roller 155 are exposed to the heating energy. For example, the conveyor substrate 160 can be warmed by the heating element 164 such that the singulated electrode 165 received by the conveyor substrate 160 can be warmed by the heating element 164. A temperature of the singulated electrodes 165 can increase as the singulated electrode moves on the conveyor substrate 160 from the notching device 135 to the magazine 188. For example, the temperature of the singulated electrode 165 can increase to dry the singulated electrode 165 (e.g., by causing moisture on or within the singulated electrode 165 to evaporate or otherwise be removed from the singulated electrode 165.

As depicted in FIG. 1B, among others, the system 100 can include a backing film 190. For example, the system 100 can include the backing film 190 between the web 130 and the backing roller 148. The backing film 190 can be provided to the system 100 in a rolled form. For example, the backing film 190 can be a continuous sheet (e.g., web, layer, film) that can be unwound from an unwinding roll 191. The backing film 190 can extend from the unwinding roll 191 to the backing roller 148. For example, the backing film 190 can extend form the unwinding roll 191 positioned downstream (e.g., in a direction opposite the first direction 162) from the notching device 135 and the backing roller 148. The backing film 190 can extend from the unwinding roll 191 to the outer surface 250 of the backing roller 148 that is closest to the roller 145 of the notching device 135. The backing film 190 can extend from the unwinding roll 191 to the backing roller 148 with the backing film 190 positioned between the outer surface 250 of the backing roller 148 and the web 130 with the web 130 positioned at the notching device 135 (e.g., between the roller 145 and the backing roller 148). The backing film 190 can wrap around an arcuate portion of the outer surface 250 of the backing roller 148 with the backing film 190 between the backing roller 148 and the web 130. The unwinding roll 191 can rotate in a first direction (e.g., the direction 157) as the backing film 190 is unwound from the unwinding roll 191. The unwinding roll 191 can freely rotate (e.g., rotate idly).

The backing film 190 can extend from the backing roller 148 to a winding roll 192. For example, the backing film 190 can be rewound on a winding roll 192 after the backing film 190 extends around an arcuate portion of the backing roller 148 with the backing film 190 between the backing roller 148 and the web 130. The backing film 190 can be rewound on the winding roll 192. The winding roll 192 can rotate in a first direction (e.g., the direction 157) to wind the backing film 190 around the winding roll 192. The winding roll 192 can be actuated (e.g., via an electric motor, a pneumatic motor, or other mechanism) to rotate the winding roll 192. As the winding roll 192 rotates, the winding roll 192 can apply a tension to the backing film 190 such that the backing film 190 is taut between the backing roller 148 and the winding roll 192. The winding roll 192 can apply a tensioning force to the backing film 190 to unwind the backing film 190 from the unwinding roll 191. For example, the winding roll 192 can apply a force to the backing film 190 as the winding roll 192 rotates, where the force can cause the backing film 190 to unwind from the unwinding roll 191. The backing film 190 can be unwound from the unwinding roll 191 and rewound by the winding roll 192.

The system 100 can include a sacrificial layer at the notching device 135. For example, the system 100 can include the backing film 190 between the backing roller 148 and the web 130 with the web 130 at the notching device 135 where the backing film 190 reduces (e.g., by 5-50%, by 50-80%, by more than 80%) wear on the backing roller 148 imparted by a force applied by the blade 140. The blade 140 of the notching device 135 can contact the backing film 190 with the backing film 190 supported on the backing roller 148 as the roller 145 rotates. For example, the distal end of the blade 140 can contact the backing film 190 with the roller 145 rotating to cut the web 130 to form the singulated electrode 165. A force applied to the backing roller 148 by the blade 140 can be reduced with the backing film 190 positioned between the blade 140 and the backing roller 148. For example, the backing film 190 can act as a buffer layer between the backing roller 148 and the blade 140 to absorb the force imparted by the blade 140. The backing film 190 can be damaged (e.g., cut, blemished, worn) with the blade 140 contacting the backing film 190. The backing film 190 can be reused or discarded after use.

The system 100 can include a separator device 175 to separate the electrode from the web 130. For example, the separator device 175 can separate the singulated electrode 165 from a web remnant 170. The notching device 135 can cut the web 130 to form at least one singulated electrode 165. As shown in FIG. 3, among others, the web remnant 170 can be a portion of the web 130 that remains after the singulated electrode 165 has been formed. The web remnant 170 can be the web 130 including openings or voids 300 that are left after the singulated electrodes 165 have been separated from the web remnant 170. The singulated electrode 165 can remain on the conveyor substrate 160 after the notching device 135 has cut the web 130 to form the singulated electrode 165. The web remnant 170 can be a sheet (e.g., web, layer) that can be wound around an axis. The web remnant 170 can be removed from the conveyor substrate 160 after the notching device 135 has cut the web 130 to form the singulated electrode 165. The separator device 175 can separate the singulated electrode 165 from the web 130 by pulling, peeling, or drawing the web remnant 170 away from the singulated electrode 165. For example, the separator device 175 can pull, peel, draw, or direct the web remnant 170 away from the conveyor substrate 160 by pulling the web remnant 170 at an angle that diverges from the to the conveyor substrate 160. As the separator device 175 pulls the web remnant 170 away from the conveyor substrate 160, the singulated electrode 165 can remain on the conveyor substrate 160. The separator device 175 can include at least one web handling device 129 to tension the web remnant 170. The web handling device 129 can also direct or guide the web remnant 170 in a particular direction (e.g., at an angle that diverges from the conveyor substrate 160).

The system 100 can include at least one roller 180 to wind the web 130 with the electrode separated. For example, the separator device 175 can separate the web remnant 170 from the singulated electrode 165. The separated web remnant 170 can be received by a roller 180. The roller 180 can be a winder or a spindle that can wind the web remnant 170 into a rolled form. For example, the roller 180 to rotate about an axis. As the roller 180 rotates about the axis, the roller 180 can wind the web remnant 170 about the axis to create a rolled web remnant 170. The separator device 175 can be or include the roller 180. For example, as the roller 180 rotates about the axis, the roller 180 can pull, peel, draw, or direct the web remnant 170 away from the conveyor substrate 160 to separate the web remnant 170 from the singulated electrode. The roller 180 can thus separate the singulated electrode 165 from the web 130 (e.g., the web remnant 170) as the roller 180 rotates, while also winding the web remnant 170 about the axis.

As depicted in FIGS. 1C, 1D, 2B, and 3B, among others, the system 100 can include the notching device 135 to cut the web 130 to form at least one notched web 198. For example, the notching device 135 can include the blade 140 to notch the web 130 to form multiple notched webs 198, where each notched web 198 can include at least one electrode portion 305 having at least one tab 235. Each notched web 198 can a film 120 laminated to a portion of the current collector material 125. For example, as discussed above, the web 130 can include multiple films 120, with each film 120 spaced apart from an adjacent film 120 with a portion of current collector material 125 extending therebetween. Each notched web 198 can include one of the multiple films 120 and the tab 235 notched from the current collector material extending between the film 120 and an adjacent film. As depicted in FIGS. 2B and 3B, the web 130 can include four films 120, where each film 120 is separated from an adjacent film 120 by a portion of the current collector material 125. For example, the first film 120 can include the first edge 215 and one intermediate edge 245, the second film 120 can be spaced apart from the first film 120 by a portion of the current collector material 125 and can include two intermediate edges 245, the third film 120 can be spaced apart from the second film 120 by a portion of the current collector material 125 and can include two intermediate edges 245, and the fourth film 120 can be spaced apart from the third film 120 by a portion of the current collector material 125 and can include an intermediate edge 245 and the second edge 220. The web 130 can include four films 120 and three portions of current collector material 125 separating each film 120.

The blade 140 of the notching device 135 can cut the web 130 to form multiple notched webs 130. For example, the blade 140 can cut the portions of the current collector material 125 to form multiple tabs 235. The blade 140 can avoid cutting any of the first film 120, the second film 120, the third film 120, and the fourth film 120. For example, rather than cutting the first film 120, the second film 120, the third film 120, or the fourth film 120, the blade can cut the portions of the current collector material 125 separating the films 120 to form multiple tabs 235. Each tab 235 can be associated with an electrode portion 305. Multiple electrode portions 305 can be continuous with (e.g., connected to, joined to) an adjacent electrode portion 305. For example, each notched web 198 can include multiple electrode portions 305, where each electrode portion 305 includes a tab 235 that has been cut by the blade 140. The notching device 135 can cut the web 130 to form the tabs 235 by applying a force via the blade 140 against the web 130. By cutting the web 130 to form the tabs 235, the blade 140 of the notching device 135 can cause the web 130 to be cut into multiple notched webs 198. Each notched web 198 can be a continuous web (e.g., sheet, layer, section). The blade 140 of the notching device 135 can cut the web 130 into multiple notched webs 198, including a first notched web 198 including the first film 120, a second notched web 198 including the second film 120, a third notched web 198 including the third film 120, and a fourth notched web 198 including the fourth film 120.

The system 100 can include at least one winding device 196 to wind at least one notched web 198. For example, the notched web 198 can be a continuous sheet (e.g., layer, web, film) that can be wound into a rolled form, rather than being singulated and collected in a magazine 188, for example. The winding device 196 can rotate about an axis. The winding device 196 can wind the notched web 198 about the axis. For example, after the web 130 has been cut by the blade to create at least one notched web 198, the winding device 196 can receive a notched web 198 (e.g., at least one of multiple notched webs 198). The winding device 196 can rotate about an axis to wind the received notched web 198 about the axis. The received notched web 198 can be a continuous web (e.g., sheet or layer) where multiple electrode portions 305 are integrally connected (e.g., joined, coupled, linked). The winding device 196 can wind the notched web 198 into a rolled form. The system 100 can include two or more winding devices 196. For example, the system 100 can include a first winding device 196 to wind the first notched web 198 into a rolled form, a second winding device 196 to wind the second notched web 198 into a rolled form, a third winding device 196 to wind the third notched web 198 into a rolled form, and a fourth winding device 196 to wind the fourth notched web 198 into a rolled form.

The system 100 can include at least one edge trimming device 199. For example, the web 130 can include at least one film 120 laminated to the current collector material 125. The current collector material can include a first edge 225 and a second edge 230. The films 120 can be spaced apart from the first edge 225 and the second edge 230. For example, a distance (e.g., 0.5-2 inches, 1-5 centimeters, or more than 5 centimeters) can exist between the first edge 225 of the current collector material 125 and the first edge 215 of the first film 120 laminated to the first side of the current collector material 125 and the second side of the current collector material 125. A distance (e.g., 0.5-2 inches, 1-5 centimeters, or more than 5 centimeters) can exist between the second edge 230 of the current collector material 125 and the second edge 220 of the fourth film 120 laminated to the first side of the current collector material 125 and the second side of the current collector material 125. The edge trimming device 199 can trim (e.g., cut, remove) a portion of the current collector material 125 between the first edge 225 and the first edge 215 of the first film 120 and between the second edge 230 and the second edge 220 of the fourth film 120, for example. As depicted in FIG. 2B, the web 130 that is notched by the notching device 135 can include the first edge 215 of the first film 120 as a first boundary of the web 130 and the second edge 220 of the fourth film 120 as a second boundary of the web 130. For example, the web 130 can be without any portion of current collector material 125 that is not between adjacent films 120 (e.g., between the first film 120 and the second film 120, between the second film 120 and the third film 120, and between the third film 120 and the fourth film 120). The edge trimming device 199 can include a blade having a sharp edge to apply a pressure to the current collector material 125 to cut the current collector material 125. The edge trimming device 135 can include a laser element to emit a laser beam to cut the current collector material 125. The edge trimming device 199 can cut the current collector material between the calendaring device 185 or the calendar-laminator 105 and the notching device 135. The edge trimming device 199 can cut the current collector material 125 as the web 130 moves in the direction 162 from the calendaring device 185 or the calendar-laminator 105 to the notching device 135.

The system 100 can include at least one rotary encoder device. For example, the system 100 can include a rotary encoder 194 coupled with the backing roller 148. The system 100 can include a second rotary encoder 194 coupled with the roller 145 of the notching device 135. The rotary encoder 194 can determine a rotational position of the backing roller 148 or a rotational position of the roller 145. The rotary encoder 194 can determine a number of rotations completed by the backing roller 148 or the roller 145. Because the blade 140 can impart a force on the backing roller 148 with the blade 140 cutting the web 130, the backing roller 148 can be prone to wear, damage, or blemishes that can affect the performance of the notching device 135. For example, the outer surface 250 of the roller 148 can experience wear with the blade 140 repeatedly contacting the same location of the outer surface 250 as the roller 145 and the backing roller 148 rotate. A force of the blade 140 against the outer surface 250 of the backing roller 148 can create an impression (e.g., groove, cavity, surface irregularity) on the outer surface 250 that can adversely affect the performance of the notching device 135. For example, with an increased distance between the distal end of the blade 140 and the outer surface 250, the blade can cause the web 130 to deflect as the blade 140 contacts the web 130 rather than cutting through the web 130.

The system 100 can include the rotary encoder 194 to monitor a rotational position of the backing roller 148 or the roller 145. For example, the rotary encoder 194 can determine an angular orientation of the backing roller 148 as having a first zone 149 (e.g., zone 1) oriented upwards as shown in FIG. 1C. The rotary encoder 194 can determine which portion of the outer surface 250 of the backing roller 148 is proximate the notching device 135 (e.g., closest to the notching device 135) at a particular time interval. The rotary encoder 194 can monitor a rotational position of the backing roller 148 to determine how many times, during a given time interval, a zone 149 of the outer surface 250 of the backing roller 148 was adjacent the notching device 135. The rotary encoder 194 can determine a rotational position of the roller 145. For example, the rotary encoder 194 can determine when the roller 145 is in an angular position such that the blade 140 or a portion of the blade 140 is in contact with the outer surface 250 of the backing roller 148. As the roller 145 rotates, the blade 140 can apply a force to the web 130 with the web 130 supported by the backing roller 148 or the backing film 190. The blade 140 can apply a force to the web 130 with the web 130 supported by a zone 149 of the outer surface 250 of the backing roller 148. The blade 140 can contact multiple zones 149 of the outer surface 250 of the backing roller 148. The blade 140 can avoid contact with multiple zones 149 of the outer surface 250 of the backing roller 148. For example, as depicted in FIG. 1C, the blade 140 can contact a first zone 149 and a third zone 149 (e.g., zones 1 and 3) of the backing roller 148. A first rotary encoder 194 can determine the rotational position of backing roller 148 and a second rotary encoder 194 can determine the rotational position of the roller 145, where the rotational position of the roller 145 corresponds to a position of the blade 140 with respect to the backing roller 148 (e.g., when the blade 140 contacts the backing roller 148). Information from the first rotary encoder 194 or the second rotary encoder 194 can be used to determine that the blade 140 contacts the outer surface 250 of the backing roller 148 in certain zones 149 (e.g., zones 1 and 3) but does not contact other zones 149 (e.g., zones 2 and 4). The first rotary encoder 194 can determine a number of times the backing roller 148 has rotated (e.g., completed a 3600 rotation) during some time interval. The second rotary encoder 194 can determine a number of times the roller 145 has rotated (e.g., completed a 3600 rotation) during some time interval.

The system 100 can include the rotary encoder 194 and an actuator to alter a position of the backing roller 148 or the roller 145. For example, the system 100 can include a first rotary encoder 194 to determine a rotational position of the backing roller 148 or the roller 145 and a number of times the backing roller 148 or the roller 145 has rotated (e.g., completed a 3600 rotation) during a time interval. At least one zone 149 (e.g., zones 1 and 3) of the outer surface 250 of the backing roller 148 can contact the blade 140 as the backing roller 148 or roller 145 rotate. For example, the first rotary encoder 194 can determine that the backing roller 148 has rotated a certain number of times (e.g., 100 times, 1000 times, 10,000 times, greater than 10,000 times) and that the blade 140 has correspondingly contacted at least one zone 149 (e.g., zones 1 and 3) the same certain number of times (e.g., 100 times, 1000 times, 10,000 times, greater than 10,000 times). The rotary encoder 194 can determine that the roller 145 has rotated a certain number of times (e.g., 100 times, 1000 times, 10,000 times, greater than 10,000 times) and that the blade 140 has correspondingly contacted at least one zone 149 (e.g., zones 1 and 3) of the backing roller 148 the same certain number of times (e.g., 100 times, 1000 times, 10,000 times, greater than 10,000 times).

The rotary encoder 194 can be communicably coupled with the actuator. For example, the rotary encoder 194 can transmit (e.g., communicate) the rotational position of the backing roller 148 or the roller 145 to the actuator. The actuator can be or include a servo motor, an electric motor, a hydraulic rotary actuator, a pneumatic rotary actuator, or some other type or actuator. The actuator can be coupled with the backing roller 148 or the roller 145 to rotate the backing roller 148 or the roller 145, respectively. For example, the actuator can rotate the backing roller 148 to alter an angular position of the backing roller 148. The actuator can cause the backing roller 148 or the roller 145 to index an eighth turn, a quarter turn, a half turn, or some amount less than a full 3600 rotation. For example, the actuator can rotate the backing roller 148 or the roller 145 by 900 (e.g., a quarter turn) with the angular position of the roller 145 remaining constant. The backing roller 148 can be rotated relative to the roller 145 such that the blade 140 no longer contacts at least one zones 149 (e.g., zones 1 and 3) of the backing roller 148, and instead contacts at least one different zone 149 (e.g., zones 2 and 4), as shown in FIG. 1D, among others.

The system 100 can include the actuator to rotate either the backing roller 148 or the roller 145 by a predefined amount (e.g., by a quarter turn, by 60°, by 30°, by some other amount) after the backing roller 148 or the roller 145 has respectively rotated a certain amount of times. For example, the actuator can index the backing roller 148 or the roller 145 by 450 after every 50,000 rotations of the backing roller 148 or the roller 145. The rotary encoder 194 can determine the number of rotations of the backing roller 148 or the roller 145 and can communicate information related to the number of rotations to the actuator. Based on the communication, the actuator can cause the roller 148 or the roller 145 to index (e.g., rotate) by a predefined amount (e.g., 45°). The rotary encoder 194 can determine how far the actuator has indexed the backing roller 148 or the roller 145 in order to control the indexing of the backing roller 148. For example, the rotary encoder 194 can determine a rotational displacement of the backing roller 148 or the roller 145 and can communicate information related to the rotational displacement of the backing roller 148 or the roller 145 to the actuator. The actuator can index the backing roller 148 or the roller 145 until the rotational displacement of the backing roller 148 reaches a predefined amount (e.g., 45°).

The system 100 can include the rotary encoder 194 and an actuator to alter a position of the backing roller 148 or the roller 145 to reduce wear on the backing roller 148. For example, by indexing the backing roller 148 relative to the roller 145 or by indexing the roller 145 relative to the backing roller 148, wear on the backing roller 148 can be reduced and the operational lifespan of the backing roller 148 can be increased. The blade 140 of the notching device 135 can contact a first zone 149 of the outer surface 250 of the backing roller 148 before the backing roller 148 or the roller 145 is indexed, as depicted in FIG. 1C. The blade 140 can contact a second zone 149 of the outer surface 250 after the backing roller 148 or the roller 145 has been indexed, as depicted in FIG. 1D. Indexing the backing roller 148 or the roller 145 at regular intervals can cause a force imparted by the blade 140 on the outer surface 250 of the backing roller 148 to be more evenly distributed than if the backing roller 148 or the roller 145 were not indexed. The system 100 can index the backing roller 148 or the roller 145 to reduce wear on the backing roller 148 even in examples where a backing film 190 is used to reduce wear on the backing roller 148 as discussed above.

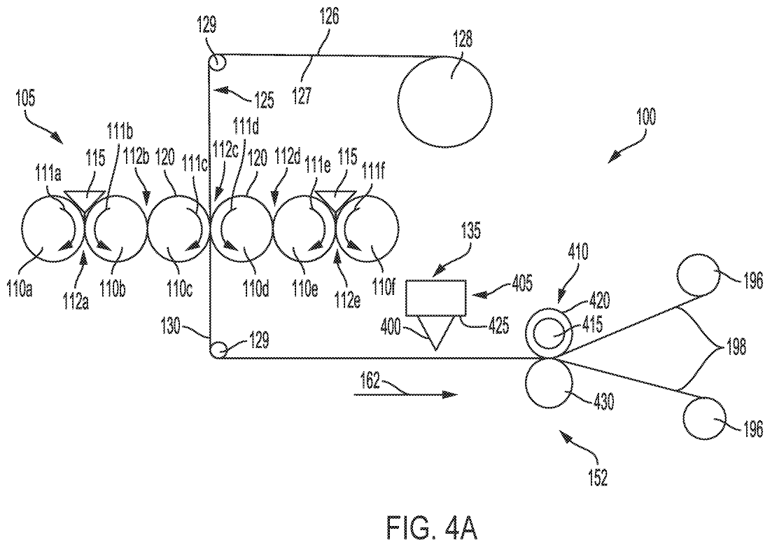

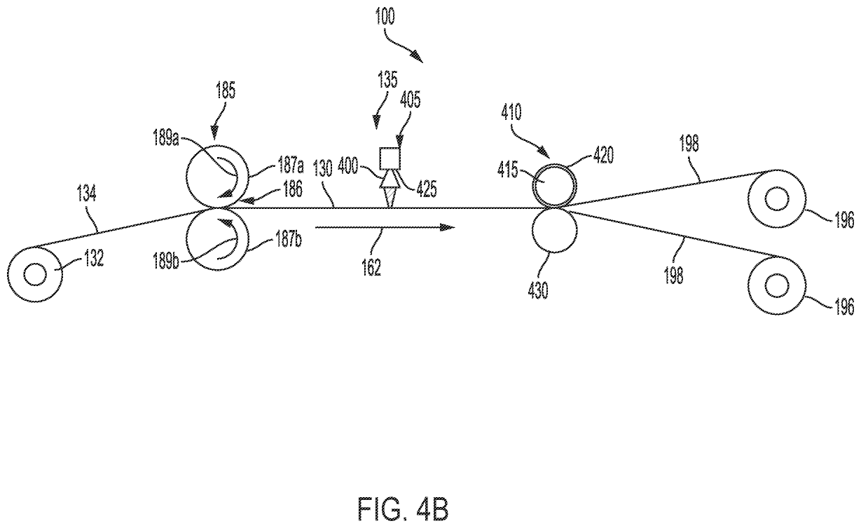

As shown in FIGS. 4A, 4B, 5, and 6, among others, the system 100 can include the notching device 135 including a laser element 400 to cut the web 130. For example, the notching device 135 can include a laser element 400 to cut the web 130 to form at least one tab 235. The notching device 135 can include the laser element 400 to cut the web 130 to form at least one electrode portion 305. The tab 235 can be an electrode tab that extends from each electrode portion 305. The tab 235 can be or include a portion of the current collector material 125 that extends beyond the first edge 215 of the film or a first edge of the second film 120. The tab 235 can be or include a portion of the current collector material 125 that extends beyond the second edge 220 of the film or the second edge of the second film 120. For example, the tab 235 can include a portion of the current collector material 125 that is not joined with (e.g., bonded with, laminated with, adhered to) the film 120 or the second film 120. The laser element 400 can cut the web 130 to remove a portion of the current collector material 125 that extends beyond a first edge 215 or second edge 220 of the film 120 or beyond a first edge or second edge of the second film 120. For example, the laser element 400 can remove a portion of the current collector material 125 and a portion of the film 120 or the second film 120 to form the tab 235. The tab 235 can be rectangular, rounded, curved, jagged, or otherwise shaped.

The laser element 400 can emit a high-power-density (e.g., 500-60,000 W) laser beam 500. The laser beam 500 can be focused, via an optical element (e.g., at least one lens) towards the web 130 to burn, melt, or vaporize a portion of the web 130. The laser beam 500 can have a focused diameter of 0.1 to 0.5 millimeters, for example. The laser element 400 can also include a nozzle element to emit a jet of gas with or instead of the laser beam 500. The jet of gas can be focused towards the web 130 to blow away any debris or cut material from the web 130. The laser element 400 can be or include a CO₂ laser, a neodymium laser, a laser microjet device including a water jet-guided laser, a fiber laser, or other laser, for example. The laser emitted by the laser element 400 can cut the web 130 to form a tab 235. For example, the laser can cut through the current collector material 125, the film 120, or the second film 120 to cut the tab 235.

The system 100 can include the notching device 135 including a laser element body 405 coupled with the laser element 400. For example, the laser element 400 can be movably coupled to a first surface 425 of the laser element body 405. The first surface 425 can be a bottom surface positioned on an underside of the laser element body 405. The laser element body 405 can extend over the web 130 with the web 130 being drawn in the direction 162 from the calendaring device 185 or the calendar-laminator 105. For example, the laser element body 405 can extend from the first edge 200 of the web 130 to the second edge 205 of the web 130. The laser element body 405 can extend in a direction that is substantially perpendicular (e.g., ±10 degrees) to the direction 162 in which the web 130 is drawn from the calendaring device 185 or the calendar-laminator. The laser element 400 can be movably coupled with the laser element body 405 such that the laser element 400 can translate along the laser element body 405 in a direction 505. For example, the laser element 400 can move in the direction 505 from a first position proximate the first edge 200 to a second position proximate the second edge 205. The laser element 400 can move in the direction 505 to any position between the first edge 200 and the second edge 205. The laser element 400 can move in the direction 162. The laser element 400 can be robotically or electro-mechanically actuated. For example, the laser element 400 can slide along a track coupled with the first surface 425 of the laser element body 405, where the laser element 400 is propelled along the track by an electric motor, a rack and pinion system, or some other device. The laser element 400 can be coupled with a linear actuator, hydraulic cylinder, pneumatic cylinder, or other device that, when actuated, can move the laser element 400 in the direction 505 or the direction 162. The notching device 135 multiple laser elements 400 that can each translate in the direction 505 or the direction 162 along the first surface 425 of the laser element body 405. The laser element 400 can move in the direction 505 or the direction 162 while the laser element 400 is emitting a laser beam 500 to cut the web 130. The laser element 400 can move in the direction 505 and the direction 162 while the web 130 is being drawn or pulled (e.g., by a web handling device 129) in the direction 162.

The system 100 can include the notching device 135 including the laser element 400 to cut the web with the web between the calendar-laminator 105 or the calendaring device 185 and the slitting device 410 or the winding device 196. The system 100 can include a calendar-laminator 105 and a slitting device 410, For example, the laser element 400 can be positioned between the calendar-laminator 105 and the slitting device 410. The system 100 can include a calendaring device 185 and a winding device 196. For example, the laser element 400 can be positioned between the calendaring device 185 and the winding device 196. The web 130 can be drawn from the calendaring device 185 or the calendar-laminator 105 in the direction 162 via a tensioning device (e.g., a web handling device 129 or the winding device 196) that can apply a tension to the web 130. The web 130 can be tensioned (e.g., taut, without slack) as it passes by the laser element 400. For example, the laser element 400 can notch the web 130 to form at least one tab 235 with the web 130 under tension. The web 130 can be unsupported (e.g., without a physical support such as a backing roller 148 or a conveyor device) as the web 130 is notched by the laser element 400.

The system 100 can include the notching device 135 including a first laser element 400 and a second laser element 400. The first laser element 400 can cut the web 130 proximate the first edge 200 to form a first tab 235 and the second laser element 400 can cut the web 130 proximate the second edge 205 to form a second tab 235. The first laser element 400 can cut the web 130 to form a first singulated electrode 165. The second laser element 400 can cut the web 130 to form a second singulated electrode 165. For example, the notching device 135 can include a first laser element 400 positioned proximate the first edge 200 of the web 130 that can translate in the direction 505 or the direction 520 along the first surface 425 of the laser element body 405. The notching device 135 can include a second laser element 400 positioned proximate the second edge 205 of the web 130 that can translate in the direction 505 or the direction 520 along the first surface 425 of the laser element body 405. The first laser element 400 can emit a laser beam 500 that can cut the web 130. The first laser element 400 can move in the direction 505 and the direction 520 while emitting the laser beam 500, where the movement of the laser element 400 causes the laser beam 500 to cut a shape of the first tab 235 (e.g., rectangular, curved, rounded, or some other shape). The second laser element 400 can emit a laser beam 500 that can cut the web 130. The second laser element 400 can move in the direction 505 and the direction 520 while emitting the laser beam 500, where the movement of the laser element 400 causes the laser beam 500 to cut a shape of the second tab 235 (e.g., rectangular, curved, rounded, or some other shape).

The system 100 can include the notching device 135 including a first laser element 400 a second laser element 400, and a third laser element 400. The first laser element 400 can cut the web 130 proximate the first edge 200 to form a first tab 235 and the second laser element 400 can cut the web 130 proximate the second edge 205 to form a second tab 235. The third laser element 400 can cut the web between the first tab 235 and the second tab 235. For example, the notching device 135 can include the first laser element 400 positioned proximate the first edge 200 of the web 130 that can translate in the direction 505 or the direction 520 along the first surface 425 of the laser element body 405. The notching device 135 can include the second laser element 400 positioned proximate the second edge 205 of the web 130 that can translate in the direction 505 or the direction 520 along the first surface 425 of the laser element body 405. The notching device 135 can include the third laser element 400 positioned between the first laser element 400 and the second laser element 400 to cut the web 130 proximate the centerline 210 of the film 120. The centerline 210 of the film 120 can be aligned with the centerline of the current collector material 125 and the second film 120 of the web 130. The first laser element 400 can emit a laser beam 500 that can cut the web 130. The first laser element 400 can move in the direction 505 and the direction 520 while emitting the laser beam 500, where the movement of the laser element 400 causes the laser beam 500 to cut a shape of the first tab 235 (e.g., rectangular, curved, rounded, or some other shape).

The second laser element 400 can emit a laser beam 500 that can cut the web 130. The second laser element 400 can move in the direction 505 and the direction 520 while emitting the laser beam 500, where the movement of the laser element 400 causes the laser beam 500 to cut a shape of the second tab 235 (e.g., rectangular, curved, rounded, or some other shape). The third laser element 400 can emit a laser beam 500 that can cut the web 130. For example, the third laser element 400 can emit a laser beam 500 that cuts the web 130 along the centerline 210 to bisect the web 130. The third laser element 400 can emit a laser beam 500 that cuts the web 130 at some other position between the first edge 200 and the second edge 205. The third laser element 400 can cut the web 130 along a straight line, a curved line, a jagged line, or some other line. The third laser element 400 can cut the web 130 in a direction that is parallel to the direction 520 or in a direction that is non-parallel with the direction 520. The third laser element 400 can cut the web 130 in half along the centerline 210 to create a first notched web 198 and a second notched web 198. The first notched web 198 and the second notched web 198 can be include dimensions (e.g., a width) that are substantially similar (e.g., less than ±5% variance). The first notched web 198 and the second notched web 198 can be differently sized such that the first notched web 198 has a width that is less than or greater than a width of the second notched web 198. Each notched web 198 can include a cut edge 600 formed by the third laser element 400. The cut edge 600 can be a straight edge, a curved line, a jagged line, or some other line according to the cutting pattern of the third laser element 400. In other examples, an edge 215, 220 of the film 120 can be aligned with an edge 225, 230 of the current collector material 125 such that a portion of the current collector material 125 is exposed only on one side of the film 120. In such instances, the third laser element 400 can cut the web 130 along some other line (e.g., a line between the centerline 210 and the first edge 225 or the second edge 230). In yet other examples, the distance between the first edge 225 of the current collector material 125 and the first edge 215 of the film 120 can be different than a distance between the second edge 230 of the current collector material 125 and the second edge 220 of the film 120 such that the third laser element 400 cuts the web 130 along some other line (e.g., a line between the centerline 210 and the first edge 225 or the second edge 230).

The system 100 can include a slitting device 410 to cut the web 130 between the first edge 200 and the second edge 205. For example, the slitting device 410 can cut the web along the centerline 210 to form the first notched web 198 and the second notched web 198. Rather than using a laser element 400 to cut the web 130 between the first edge 200 and the second edge 205, the system 100 can include a separate slitting device 410 that cuts the web 130 between the first edge 200 and the second edge 205 of the web 130. For example, the slitting device 410 can be include a roller 415 and a cutting element such as a blade 420. The roller 415 can rotate about an axis. The roller 415 can include an outer surface 515. The outer surface 515 can be positioned proximate to the web 130, for example. The blade 420 (or other cutting element) can be a coupled with the outer surface 515 of the roller 415. For example, the blade 420 can be a flexible blade that can match the curvature of the roller 415. The blade 420 can extend perpendicular to the outer surface 515 of the roller 415. A distal end of the blade 420 (e.g., the end extending away from the outer surface 515 of the roller 415) can be sharp such that blade can cut through the web 130 or other material. The blade 420 can cut the web 130 as the roller 415 rotates. For example, as the roller 415 rotates about the axis, the blade 420 can contact the web 130. The rotation of the roller 415 can cause the blade 420 to contact the web 130 with force (e.g., pressure against the web 130) such that the blade 420 cuts through the web 130. For example, the blade 420 can contact the web 130 with sufficient force that the blade 420 can cut through the film 120, the current collector material 125, and the second film 120. The blade 420 can cut the web 130 along the centerline 210 of the film 120 or along some other line between the first edge 200 and the second edge 205 to form the first notched web 198 and the second notched web 198. The first notched web 198 and the second notched web 198 can include the cut edge 600 formed by the blade 420. The edge 600 can be a straight edge, a curved line, a jagged line, or some other pattern according to the cutting pattern of the blade 420.

The system 100 can include the slitting device 410 including the blade 420 coupled with the roller 415 and a second roller, the blade 420 to cut the web 130 between the first roller 415 and the second roller. As shown in FIG. 4, the second roller can be a second roller 430. The second roller can be a backing roller or an anvil roller, such as the second roller 430. The second roller 430 can be positioned beneath (e.g., vertically disposed below) the roller 415 of the slitting device 410. The second roller 430 can be directly beneath or offset from the roller 415. The second roller 430 can be spaced apart from the roller 415 such that a gap exists between the outer surface 515 of the roller 415 and an outer surface of the second roller 430. The blade 420 can cut the web 130 with the web 130 supported by the second roller 430. For example, the blade 420 can apply a pressure to the web 130 and the second roller 430 as the blade 420 cuts the web 130. The second roller 430 can support an underside of the web 130 to reduce an amount of deflection of the web 130 as the blade 420 cuts the web 130 or minimize vibration of the web 130. A reaction force that at least partially opposes a force of the blade 420 against the web 130 can be provided by the second roller 430. For example, the blade 420 can cut the web 130 to form a singulated electrode with the second roller 430 substantially preventing (e.g., reducing by 95%) a deflection of the web 130.

The system 100 can include the slitting device 410 to cut the web 130 after the notching device 135 cuts the web 130. For example, the notching device 135 can cut the web 130 to form a first tab 235 as the web 130 moves in the first direction 520. After the web 130 is cut by the notching device 135, the web 130 can continue to move in the direction 162. For example, a tension can be applied to the web 130 to pull the web 130 in the direction 162 from the notching device 135 to the slitting device 410. The web 130 can be pulled in the direction 162 from the notching device 135 to the slitting device 410. The web 130 can be pulled in the direction 162 from the notching device 135 and through the slitting device 410 (e.g., between the roller 415 and the second roller 430) such that the blade 420 of the roller 415 can cut (e.g., bisect) the web 130 into the notched webs 198 as the web 130 passes through the slitting device 410.

As shown in FIG. 4, among others, the system 100 can include at least one winding device 196 to wind the notched web 198. For example, the system 100 can include at least one winding device 196 that winds the notched web 198 into a rolled configuration. The winding device 196 can rotate about an axis. The winding device 196 can wind the notched web 198 about the axis. For example, after the web 130 has been cut by a laser element 400 or a slitting device 410 to create at least one notched web 198, the winding device 196 can receive a notched web 198. The winding device 196 can rotate about an axis to wind the received notched web 198 about the axis. The received notched web 198 can be a continuous web (e.g., sheet or layer) where multiple electrode portions 305 are integrally connected (e.g., joined, coupled, linked). The winding device 196 can wind the notched web 198 in to a rolled form. The system 100 can include two or more winding devices 196. For example, the system 100 can include a first winding device 196 to wind the first notched web 198 into a rolled form. The system 100 can include a second winding device 196 to wind the second notched web 198 in to a rolled form.

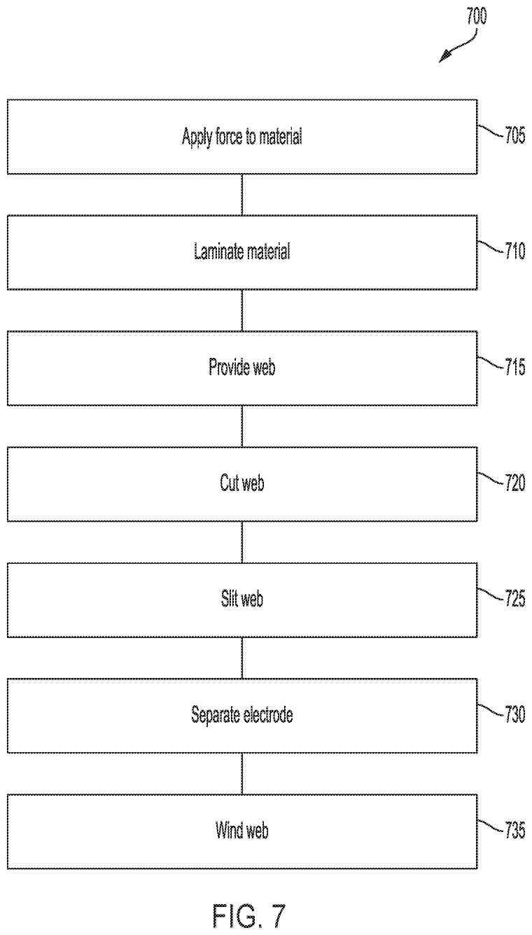

FIG. 7 depicts a flowchart of a method 700 of manufacturing a battery electrode with the system 100. The method 700 can include one or more of ACTS 705-735. The method 700 can be performed by the system 100, one or more of the components associated therewith, or some other components of some other system.

The method 700 can include applying a force to a material. (ACT 705.) For example, the method 700 can include applying a shearing force or a compressive force, via a first roller and a second roller of a calendaring device (e.g., the calendaring device 185 or the calendar-laminator 105), to the material to form the film 120. The material can be a dry powdered, slurry, aqueous, or other material. The material can be a battery active material. In examples where the calendaring device is a calendar-laminator, the first roller can be the roller 110a, for example. The first roller can be some other roller 110, such as roller 110b. The second roller can be the roller 110b, for example. The second roller can be some other roller 110, such as the roller 110c. The method 700 can include shearing the material with different rollers 110. For example, the method 700 can include shearing the material with the roller 110a and the roller 110b, with the roller 110f and the roller 110e, or with the roller 110e and the roller 110d. The method 700 can include applying a force (e.g., shearing or compressing) to a battery active material at the pressure point 112a. The method 700 can include shearing the material at different or multiple pressure points 112. For example, the method 700 can include shearing the material with the pressure point 112b, the pressure point 112e, or the pressure point 112d. The infeed device 115 can provide the material to or between the roller 110a and the roller 110b at the pressure point 112a, for example. The second infeed device 115 can provide the material to the roller 110f and the roller 110e at the pressure point 112e, for example. The material can be manipulated (e.g., sheared or compressed) through the pressure point 112a as the roller 110a rotates in the direction 111a and the roller 110b rotates in the direction 111b towards the pressure point 112a to pull or draw the material into and through the pressure point 112a between the roller 110a and the roller 110b. As the material is drawn through the pressure point 112a, it can be compressed or sheared to form the film 120. In some examples, the roller 110a can rotate in the direction 111a at a first speed and first angular velocity, while the roller 110b can contra-rotate in the second direction 111b at a second speed and second angular velocity, where the first speed or first angular velocity can be less than the second speed or second angular velocity, respectively. A difference in speed or angular velocity of the roller 110a and the roller 110b can create a shearing force that shears the material as it passes through the first pressure point 112a. The method 700 can include applying a force to (e.g., shearing or compressing) the material at two pressure points to create the film 120 and the second film 120. For example, the method 700 can include applying a force to (e.g., shearing or compressing) the material at the pressure point 112a to create the film 120 and shearing a material at the pressure point 112e to create the second film 120.

The method 700 can include applying a force to a material via a calendaring device 185 at ACT 705. For example, the method 700 can include receiving a web 134 between a roller 187a and a roller 187b of the calendaring device 185. The roller 187a and the roller 187b can define a pressure point 186. The calendaring device 185 can receive the web 134 at the pressure point 186 to apply a compressive force to the web 134. The web 134 can be compressed to form the web 130. The web 134 can be provided to the calendaring device 185 via a roll 132. For example, the web 134 can include a battery active material that has already been laminated to a current collector material (e.g., the current collector material 125) via a calendar-laminator device (e.g., the calendar-laminator 105) or a slot die coating system (e.g., wet or semi-wet slurry applied to a current collector material) that is separate from (e.g., located remotely from, does not include) the calendaring device 185. For example, the method 700 can include calendaring the web 134 at ACT 705 to form the web 130, rather than applying a force to a material to form a film 120 which can then be laminated to a current collector material in a subsequent ACT.

The method 700 can include laminating the material. (ACT 710.) For example, the method 700 can include laminating the film 120 to the current collector material 125 to form the web 130. The method 700 can include laminating the film 120 to the current collector material 125 between the roller 110c and the roller 110d, for example. The method 700 can include laminating the film 120 with the current collector material 125 to produce the web 130, where the film 120 can be created by shearing the material at ACT 705. The method 700 can include laminating the film 120 with at least one of the first side 126 or the second side 127 of the current collector material 125. The method 700 can include laminating the film 120 with the current collector material 125 with the roller 110c and the roller 110d. For example, the method 700 can include laminating the film 120 with the current collector material 125 at the pressure point 112c. The roller 110c and the roller 110d can receive the film 120 or the second film 120 produced at ACT 705 and the current collector material 125. For example, the roller 110c and the roller 110d can laminate the film 120 with the first side 126 of the current collector material 125 at the pressure point 112c. The roller 110c and the roller 110d can laminate the second film 120 with the second side 127 of the current collector material 125 at the pressure point 112c.

The roller 110c and the roller 110d can rotate inwards towards the pressure point 112c to pull or draw the film 120, the second film 120, or the current collector material 125 into and through the pressure point 112c between the roller 110c and the roller 110d. The film 120 can contact (e.g., abut, be adjacent to) the first side 126 of the current collector material 125 as the film 120 and the current collector material 125 enter the pressure point 112c. The second film 120 can contact (e.g., abut, be adjacent to) the second side 127 of the current collector material 125 as the second film 120 and the current collector material 125 enter the pressure point 112c. As the film 120, the current collector material 125, or the second film 120 are drawn through the pressure point 112c, the film 120 can be laminated with the first side 126 of the current collector material 125 to form the web 130. As the film 120, the current collector material 125, or the second film 120 are drawn through the pressure point 112c, the second film 120 can be laminated with the second side 127 of the current collector material 125 to form the web 130. The web 130 can include the film 120, the second film 120, or both of the film 120 and the second film 120. When laminated, film 120 and the current collector material 125 can be joined such that the film 120 cannot easily be separated from the first side 126 of the current collector material 125 (e.g., without use of substantial force). When laminated, second film 120 and the current collector material 125 can be joined such that the second film 120 cannot easily be separated from the second side 127 of the current collector material 125 (e.g., without use of substantial force).

ACT 710 can be optional. For example, as indicated above, the method 700 can include applying a force to a material via the calendaring device 185 instead of via the calendar-laminator 105. The method 700 can include applying a compressive (e.g., calendaring) force to the web 134 to form the web 130, where the web 134 can include a battery active material that has already been laminated to the current collector material 125. For example, ACT 710 can be unnecessary with the web 134 including the battery active material laminated to the current collector material 125. The calendaring device 185 can apply a force to the web 134 to create the web 130, where creating the web 130 can include compressing the web 134 without laminating anything to the web 134, to the current collector 125, or otherwise.

The method 700 can include providing the web 130. (ACT 715.) For example, the method 700 can include providing the web 130 to the notching device 135 from the calendaring device (e.g., the calendaring device 185 or the calendar-laminator 105). The method 700 can include providing the web 130 from the pressure point 186 of the calendaring device 185 to the notching device 135 via at least one web handling device 129. The method 700 can include providing the web 130 from the pressure point 112c of the calendar-laminator 105 to the notching device 135 via at least one web handling device. The web handling device 129 can be positioned downstream of the notching device 135 (e.g., spaced apart from the notching device 135 in the direction 162). A second web handling device 129 can be positioned upstream of the notching device 135 (e.g., spaced apart from the notching device 135 in a direction opposite the direction 162). The method 700 can include providing the web 130 from the calendaring device 185 or the calendar-laminator 105 to the notching device 135 direction (e.g., without any intervening components or web handing devices 129 positioned between the calendaring device 185 and the notching device 135. For example, the notching device 135 can apply a tension to the web 130 to pull (e.g., draw, direct, or guide) the web 130 in the direction 162 from the calendaring device 185 or the calendar-laminator 105 towards the notching device 135. In examples where the web handling device 129 is used, the web handling device 129 can redirect the web 130 such that a direction of the web 130 changes from substantially vertical (e.g., ±30 degrees from vertical) to substantially horizontal (e.g., ±30 degrees from horizontal) or some other orientation as the web 130 moves from the calendaring device 185 or the calendar-laminator 105 to the notching device 135.

The method 700 can include cutting the web 130. (ACT 720). For example, the method 700 can include cutting, via the notching device 135, the web 130. The method 700 can include cutting the web 130 via the notching device 135 to form a singulated electrode 165 or a notched web 198 including at least one electrode portions 305. The notching device 135 can include a blade 140 or a laser element 400. For example, the blade 140 can be coupled with a roller 145 that rotates proximate to the web 130 while the web 130 is supported by the backing roller 148. The method 700 can include cutting the web 130 via the blade 140 of the notching device 135 as the rotation of the roller 145 causes the blade to contact the web 130. For example, the roller 145 and the blade 140 can apply a pressure to the web 130 as the web 130 is supported by the backing roller 148, where the pressure causes the blade 140 to slice through the web 130 to cut the web. The notching device 135 can include at least one laser element 400 that emits a laser beam 500 that can cut the web 130. For example, the laser element 400 can emit a high-power-density (e.g., 500 W to 60,000 W) laser beam 500 to cut the web 130 as the web 130 passes under the laser element 400. The method 700 can include cutting at least one tab 235 with the laser element 400. The method 700 can include cutting the web 130 between the first edge 200 and the second edge 205 of the web 130 (e.g., along the centerline 210) with the laser element 400 to form two or more notched webs 198.

The method 700 can include cutting, via the notching device 135, the web 130 proximate the first edge 200 of the web to form a first tab and proximate the second edge 205 of the web 130 to form a second tab. The first tab can be the tab 235 formed by the blade 140 or the tab 235 formed by the laser element 400. The second tab can a tab 235 formed by the blade 140 or a tab 235 formed by the laser element. For example, the notching device 135 can include a first laser element 400 positioned to cut the web 130 proximate the first edge 200 and a second laser element 400 positioned to cut the web 130 proximate the second edge 205. The first laser element 400 can cut the first tab 235, while the second laser element 400 can cut the second tab 235. The notching device 135 can include a first blade 140 and a second blade 140. The first blade 140 can be positioned proximate the first edge 200 and can cut the web 130 to form the first tab 235. The second blade 140 can be positioned proximate the second edge 205 and can cut the web 130 to form the second tab 235.

The method 700 can include slitting the web 130. (ACT 725.) For example, the method 700 can include cutting, via a slitting device 410, the web 130 between the first edge 200 and the second edge 205. The slitting device 410 can include the blade 420 coupled with the roller 415. The method 700 can include cutting the web 130 with the blade 420 as the roller 415 rotates with the web 130 supported on the second roller 430. For example, the roller 415 or the blade 420 can apply a pressure to the web 130 as the web 130 is supported by the second roller 430, where the pressure causes the blade to slice through the web 130 to cut the web 130. The blade 420 can cut the web 130 proximate the centerline 210 or at some other position between the first edge 200 and the second edge 205 to form two or more notched webs 198.

The method 700 can include cutting, via a first cutting element, a second cutting element, and a third cutting element, the web 130. For example, the method 700 can include cutting the web 130 via a first cutting element to form a first tab 235. The first cutting element can be the first laser element 400, where the first laser element 400 can emit a laser beam 500 to cut the web 130 proximate the first edge 200 of the web 130 to form the first tab 235. The method 700 can include cutting the web 130 via a second cutting element to form a second tab 235. The second cutting element can be the second laser element 400, where the second laser element 400 can emit a laser beam 500 to cut the web 130 proximate the second edge 205 of the web 130 to form the second tab 235. The method 700 can include cutting the web 130 between the first edge 200 and the second edge 205 via the third cutting element. For example, the method 700 can include bisecting the web 130 to form two or more notched webs 198 via the third cutting element. The third cutting element can be the third laser element 400, where the third laser element 400 can emit a laser beam 500 to cut the web 130 between the first edge 200 and the second edge 205 to bisect the web 130. The third cutting element can also be the slitting device 410 or other cutting element.

The method 700 can include separating the electrode 165. (ACT 730.) For example, the method 700 can include separating, by the separator device 175, at least one singulated electrode 165 from the web 130. The notching device 135 can cut the web 130 to form a singulated electrode 165. A web remnant 170 can be generated with the singulated electrode 165 cut from the web 130. The method 700 can include separating the singulated electrode 165 from the web remnant 170 with the separator device 175 pulling, peeling, or drawing the web remnant 170 away from the singulated electrode 165. For example, the separator device 175 can pull, peel, draw, or direct the web remnant 170 away from the conveyor substrate 160 by pulling the web remnant 170 at an angle that diverges from the to the conveyor substrate 160. As the separator device 175 pulls the web remnant 170 away from the conveyor substrate 160, the singulated electrode 165 can remain on the conveyor substrate 160. The separator device 175 can include at least one web handling device 129 to tension the web remnant 170. The web handling device 129 can also direct or guide the web remnant 170 in a particular direction (e.g., at an angle that diverges from the conveyor substrate 160).

The method 700 can include winding the web 130. (ACT 735.) The method 700 include winding, by a roller 180, the web 130 with the electrode separated. For example, the method 700 can include winding, by the roller 180, the web remnant 170 about an axis after the singulated electrode 165 has been separated from the web remnant 170 via the separator device 175. The separated web remnant 170 can be received by a roller 180. The roller 180 can wind the web remnant 170 into a rolled form. For example, the roller 180 to rotate about an axis. As the roller 180 rotates about the axis, the roller 180 can wind the web remnant 170 about the axis to create a rolled web remnant 170. The separator device 175 can be or include the roller 180. For example, as the roller 180 rotates about the axis, the roller 180 can pull, peel, draw, or direct the web remnant 170 away from the conveyor substrate 160 to separate the web remnant 170 from the singulated electrode. The roller 180 can thus separate the singulated electrode 165 from the web 130 (e.g., the web remnant 170) as the roller 180 rotates, while also winding the web remnant 170 about the axis. The method 700 can include winding, by at least one winding device 196, at least one notched web 198. For example, the method 700 can include winding the notched web 198 into a rolled form via the winding device 196.

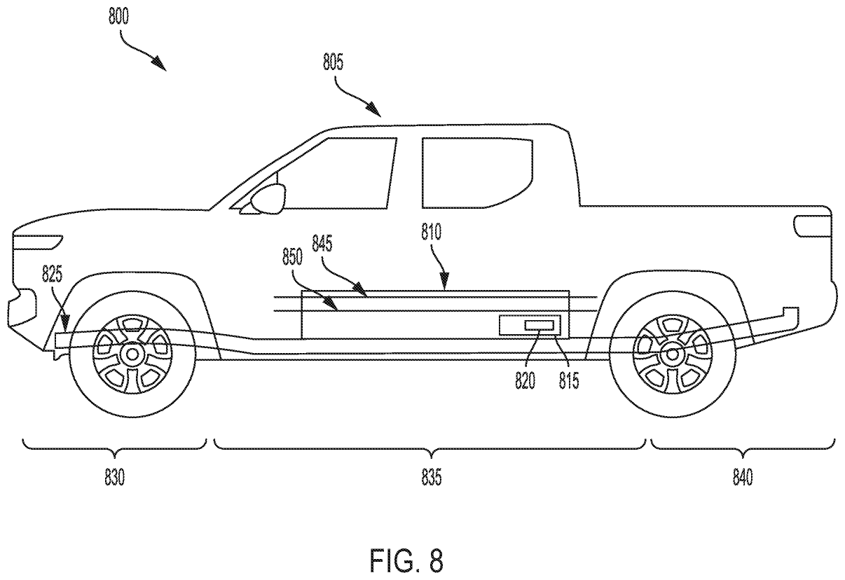

FIG. 8 depicts is an example cross-sectional view 800 of an electric vehicle 805 installed with at least one battery pack 810. Electric vehicles 805 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 810 can also be used as an energy storage system to power a building, such as a residential home or commercial building. Electric vehicles 805 can be fully electric or partially electric (e.g., plug-in hybrid) and further, electric vehicles 805 can be fully autonomous, partially autonomous, or unmanned. Electric vehicles 805 can also be human operated or non-autonomous. Electric vehicles 805 such as electric trucks or automobiles can include on-board battery packs 810, battery modules 815, or battery cells 820 to power the electric vehicles. The battery cells 820 can include at least one battery electrode manufactured using the system 100 of FIGS. 1-2 and 4-5 or the method 700 of FIG. 7, for example.

The electric vehicle 805 can include a chassis 825 (e.g., a frame, internal frame, or support structure). The chassis 825 can support various components of the electric vehicle 805. The chassis 825 can span a front portion 830 (e.g., a hood or bonnet portion), a body portion 835, and a rear portion 840 (e.g., a trunk, payload, or boot portion) of the electric vehicle 805. The battery pack 810 can be installed or placed within the electric vehicle 805. For example, the battery pack 810 can be installed on the chassis 825 of the electric vehicle 805 within one or more of the front portion 830, the body portion 835, or the rear portion 840. The battery pack 810 can include or connect with at least one busbar, e.g., a current collector element. For example, the first busbar 845 and the second busbar 850 can include electrically conductive material to connect or otherwise electrically couple the battery modules 815 or the battery cells 820 with other electrical components of the electric vehicle 805 to provide electrical power to various systems or components of the electric vehicle 805.

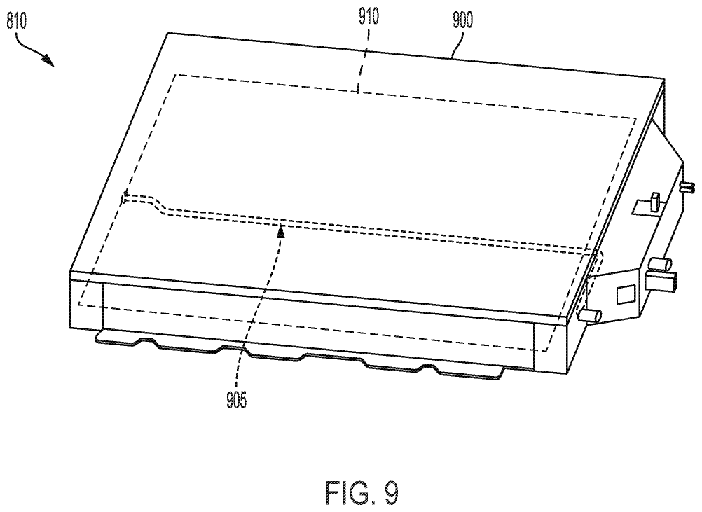

FIG. 9 depicts an example battery pack 810. Referring to FIG. 9, among others, the battery pack 810 can provide power to electric vehicle 805. Battery packs 810 can include any arrangement or network of electrical, electronic, mechanical or electromechanical devices to power a vehicle of any type, such as the electric vehicle 805. The battery pack 810 can include at least one housing 900. The housing 900 can include at least one battery module 815 or at least one battery cell 820, as well as other battery pack components. The battery module 815 can be or can include one or more groups of prismatic cells, cylindrical cells, pouch cells, or other form factors of battery cells 820. The housing 900 can include a shield on the bottom or underneath the battery module 815 to protect the battery module 815 and/or cells 820 from external conditions, for example if the electric vehicle 805 is driven over rough terrains (e.g., off-road, trenches, rocks, etc.) The battery pack 810 can include at least one cooling line 905 that can distribute fluid through the battery pack 810 as part of a thermal/temperature control or heat exchange system that can also include at least one thermal component (e.g., cold plate) 910. The thermal component 910 can be positioned in relation to a top submodule and a bottom submodule, such as in between the top and bottom submodules, among other possibilities. The battery pack 810 can include any number of thermal components 910. For example, there can be one or more thermal components 910 per battery pack 810, or per battery module 815. At least one cooling line 905 can be coupled with, part of, or independent from the thermal component 910.

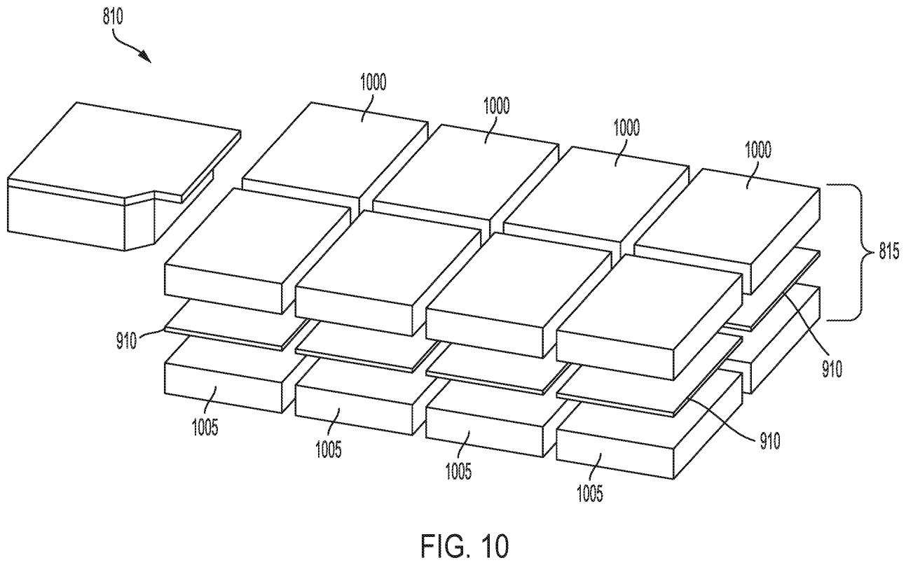

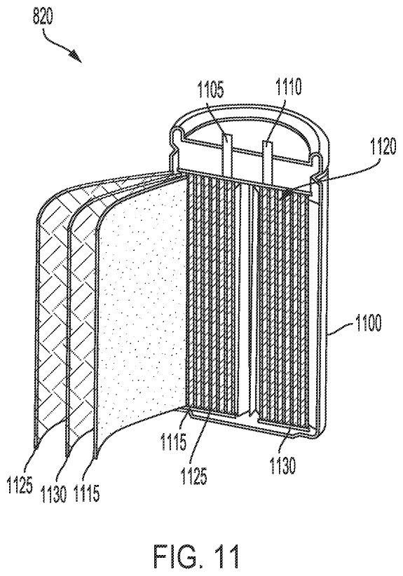

FIG. 10 depicts example battery modules 815, and FIG. 11 depicts an example cross sectional view of a battery cell 820. The battery modules 815 can include at least one submodule. For example, the battery modules 815 can include at least one top submodule 1000 or at least one bottom submodule 1005. At least one thermal component 910 can be disposed between the top submodule 1000 and the bottom submodule 1005. For example, one thermal component 910 can be configured for heat exchange with one battery module 815. The thermal component 910 can be disposed or thermally coupled between the top submodule 1000 and the bottom submodule 1005. One thermal component 910 can also be thermally coupled with more than one battery module 815 (or more than two submodules 1000, 1005). The battery submodules 1000, 1005 can collectively form one battery module 815. In some examples each submodule 1000, 1005 can be considered as a complete battery module 815, rather than a submodule.

The battery modules 815 can each include a plurality of battery cells 820. The battery modules 815 can be disposed within the housing 900 of the battery pack 810. The battery modules 815 can include battery cells 820 such as cylindrical, prismatic, or pouch cells, for example. The battery module 815 can operate as a modular unit of battery cells 820. For example, a battery module 815 can collect current or electrical power from the battery cells 820 that are included in the battery module 815 and can provide the current or electrical power as output from the battery pack 810. The battery pack 810 can include any number of battery modules 815. For example, the battery pack can have one, two, three, four, five, six, seven, eight, nine, ten, eleven, twelve or other number of battery modules 815 disposed in the housing 900. It should also be noted that each battery module 815 may include a top submodule 1000 and a bottom submodule 1005, possibly with a thermal component 910 in between the top submodule 1000 and the bottom submodule 1005. The battery pack 810 can include or define a plurality of areas for positioning of the battery module 815 and/or cells 820. The battery modules 815 can be square, rectangular, circular, triangular, symmetrical, or asymmetrical. In some examples, battery modules 815 may be different shapes, such that some battery modules 815 are rectangular but other battery modules 815 are square shaped, among other possibilities. The battery module 815 can include or define a plurality of slots, holders, or containers for a plurality of battery cells 820.

Battery cells 820 have a variety of form factors, shapes, or sizes. For example, battery cells 820 can have a cylindrical, rectangular, square, cubic, flat, pouch, elongated or prismatic form factor. Battery cells 820 can be assembled, for example, by inserting a winded or stacked electrode roll (e.g., a jelly roll) including electrolyte material into at least one battery cell housing 1100. The electrolyte material, e.g., an ionically conductive fluid or other material, support electrochemical reactions at the electrodes to generate, store, or provide electric power for the battery cell by allowing for the conduction of ions between a positive electrode and a negative electrode. The battery cell 820 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 820. The housing 1100 can be of various shapes, including cylindrical or rectangular, for example. Electrical connections can be made between the electrolyte material and components of the battery cell 820. For example, electrical connections to the electrodes with at least some of the electrolyte material can be formed at two points or areas of the battery cell 820, for example to form a first polarity terminal 1105 (e.g., a positive or anode terminal) and a second polarity terminal 1110 (e.g., a negative or cathode terminal). The polarity terminals can be made from electrically conductive materials to carry electrical current from the battery cell 820 to an electrical load, such as a component or system of the electric vehicle 805. As indicated above, at least one of the electrodes of the battery cells 820 can be manufactured by the systems (e.g., system 100) and processes (e.g., method 700) described herein.

For example, the battery cell 820 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 820 to separate the anode and cathode from each other and to facilitate transfer of lithium ions between the anode and cathode. It should be noted that battery cell 820 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 820 can be included in battery modules 815 or battery packs 810 to power components of the electric vehicle 805. The battery cell housing 1100 can be disposed in the battery module 815, the battery pack 810, or a battery array installed in the electric vehicle 805. The housing 1100 can be of any shape, such as cylindrical with a circular (e.g., as depicted), elliptical, or ovular base, among others. The shape of the housing 1100 can also be prismatic with a polygonal base, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 1100 of the battery cell 820 can include one or more materials with various electrical conductivity or thermal conductivity, or a combination thereof. The electrically conductive and thermally conductive material for the housing 1100 of the battery cell 820 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1100 of the battery cell 820 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1100 of the battery cell 820 is prismatic or cylindrical, the housing 1100 can include a rigid or semi-rigid material such that the housing 1100 is rigid or semi-rigid (e.g., not easily deformed or manipulated into another shape or form factor). In examples where the housing 1100 includes a pouch form factor, the housing 1100 can include a flexible, malleable, or non-rigid material such that the housing 1100 can be bent, deformed, manipulated into another form factor or shape.

The battery cell 820 can include at least one anode layer 1115, which can be disposed within the cavity 1120 defined by the housing 1100. The anode layer 1115 can include a first redox potential. The anode layer 1115 can receive electrical current into the battery cell 820 and output electrons during the operation of the battery cell 820 (e.g., charging or discharging of the battery cell 820). The anode layer 1115 can include an active substance. The active substance can include, for example, an activated carbon or a material infused with conductive materials (e.g., artificial or natural Graphite, or blended), lithium titanate (Li₄Ti₅O₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state. The anode layer 1115 can be an electrode manufactured by the system 100 or according to the method 700, for example.

The battery cell 820 can include at least one cathode layer 1125 (e.g., a composite cathode layer compound cathode layer, a compound cathode, a composite cathode, or a cathode). The cathode layer 1125 can include a second redox potential that can be different than the first redox potential of the anode layer 1115. The cathode layer 1125 can be disposed within the cavity 1120. The cathode layer 1125 can output electrical current out from the battery cell 820 and can receive electrons during the discharging of the battery cell 820. The cathode layer 1125 can also release lithium ions during the discharging of the battery cell 820. Conversely, the cathode layer 1125 can receive electrical current into the battery cell 820 and can output electrons during the charging of the battery cell 820. The cathode layer 1125 can receive lithium ions during the charging of the battery cell 820. The cathode layer 1125 can be an electrode manufactured by the system 100 or according to the method 700, for example.

The battery cell 820 can include an electrolyte layer 1130 disposed within the cavity 1120. The electrolyte layer 1130 can be arranged between the anode layer 1115 and the cathode layer 1125 to separate the anode layer 1115 and the cathode layer 1125. The electrolyte layer 1130 can facilitate the transfer of ions between the anode layer 1115 and the cathode layer 1125. The electrolyte layer 1130 can transfer Li⁺ cations from the anode layer 1115 to the cathode layer 1125 during the discharge operation of the battery cell 820. The electrolyte layer 1130 can transfer anions (e.g., lithium ions) from the cathode layer 1125 to the anode layer 1115 during the charge operation of the battery cell 820.

The redox potential of layers (e.g., the first redox potential of the anode layer 1115 or the second redox potential of the cathode layer 1125) can vary based on a chemistry of the respective layer or a chemistry of the battery cell 820. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 1125). Lithium-ion batteries can include a graphite chemistry, a silicon-graphite chemistry, or a lithium metal chemistry for the anode layer (e.g., the anode layer 1115).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Ox, M=Ti, V, Mn, Cr, and Zr), for example Lithium iron phosphate (LFP), Lithium iron manganese phosphate (LMFP), a layered oxides (LiMO₂, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 1125). Lithium-ion batteries can include a graphite chemistry, a silicon-graphite chemistry, or a lithium metal chemistry for the anode layer (e.g., the anode layer 1115). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 1125) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 1115) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 1130 can include or be made of a liquid electrolyte material. For example, the electrolyte layer 1130 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 1130 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 1130 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (Li_{X}PO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

The battery cell 820 can include at least one electrode layer (e.g., the anode layer 1115 or the cathode layer 1125) that are manufactured by the system 100 or via the method 700. For example, the anode layer 1115 or the cathode layer 1125 can be at least partially manufactured by applying a force (e.g., a shearing force or a compressive force), via a first roller (e.g., roller 110b) and a second roller (e.g., roller 110c) of the calendar-laminator 105, a material to form the film 120. The anode layer 1115 or the cathode layer 1125 can be at least partially manufactured by laminating, via the second roller and a third roller (e.g., roller 110d) of the calendar-laminator 105, the film 120 to the current collector material 125 to form the web 130. In other embodiments, the anode layer 1115 or the cathode layer 1125 can be manufactured by applying a force (e.g., a compressive calendaring force), via the calendaring device 185, to the web 134 to form the web 130. The anode layer 1115 or the cathode layer 1125 can be at least partially manufactured by providing the web 130 to the notching device 135. The anode layer 1115 or the cathode layer 1125 can be at least partially manufactured by cutting, via the notching device 135, the web 130. The anode layer 1115 or the cathode layer 1125 can be at least partially manufactured by cutting, via a first cutting element (e.g., the blade 140 or the laser element 400), a tab (e.g., the tab 235 or the tab 235). The anode layer 1115 or the cathode layer 1125 can be at least partially manufactured by separating the electrode from the web 130 via a separator device 175.

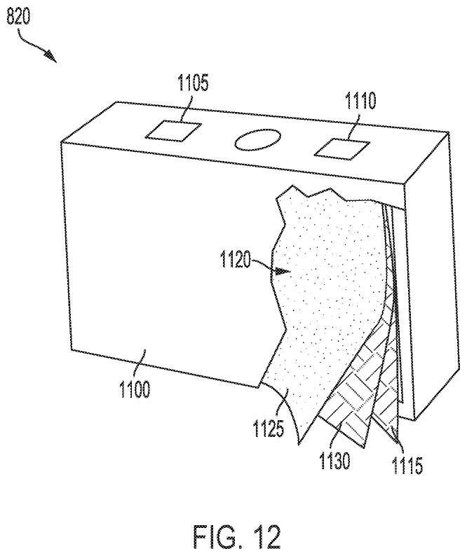

FIG. 12, among others, depicts an example cross sectional view of a battery cell 820. For example, the battery cell 820 can be a prismatic battery cell. The battery cell 820 can include a prismatic housing 1100. The housing 1100 can define a cavity 1120. The battery cell 820 a first polarity terminal 1105 (e.g., a positive or anode terminal) and a second polarity terminal 1110 (e.g., a negative or cathode terminal). The polarity terminals can be made from electrically conductive materials to carry electrical current from the battery cell 820 to an electrical load, such as a component or system of the electric vehicle 805.

The housing 1100 can include one or more materials with various electrical conductivity or thermal conductivity, or a combination thereof. The electrically conductive and thermally conductive material for the housing 1100 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1100 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 820 can include the anode layer 1115 disposed within the cavity 1120 defined by the housing 1100. The battery cell 820 can include the cathode layer 1125 disposed within the cavity 1120. The battery cell 820 can include the electrolyte layer 1130 disposed within the cavity 1120. For example, the electrolyte layer 1130 can be arranged between the anode layer 1115 and the cathode layer 1125 to separate the anode layer 1115 and the cathode layer 1125.

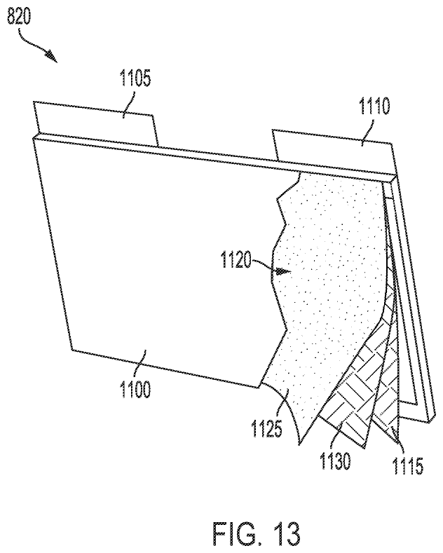

FIG. 13, among others, depicts an example cross sectional view of a battery cell 820. For example, the battery cell 820 can be a pouch battery cell. The battery cell 820 can include an exterior pouch 1100 that defines the cavity 1120. The exterior pouch 1100 can be a non-rigid, soft, or semi-soft case that encloses at least one battery electrode. For example, the battery cell 820 can include the anode layer 1115 disposed within the cavity 1120 defined by the housing 1100. The battery cell 820 can include the cathode layer 1125 disposed within the cavity 1120. The battery cell 820 can include the electrolyte layer 1130 disposed within the cavity 1120. For example, the electrolyte layer 1130 can be arranged between the anode layer 1115 and the cathode layer 1125 to separate the anode layer 1115 and the cathode layer 1125. The anode layer 1115, the cathode layer 1125, or the electrolyte layer 1130 can be rolled or wrapped within the cavity 1120. The pouch 1100 can be vacuum sealed around the anode layer 1115, the cathode layer 1125, or the electrolyte layer 1130 such that the anode layer 1115, the cathode layer 1125, or the electrolyte layer 1130 are encapsulated (e.g., enclosed, sealed, enveloped) by the pouch 1100.

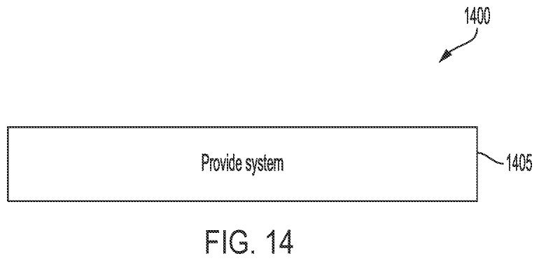

FIG. 14 depicts a flowchart of a method 1400. The method 1400 can include providing a system. (ACT 1405.) For example, the method 1400 can include providing a system 100 for manufacturing a battery electrode. The method 1400 can include providing the system 100 that includes a calendar-laminator 105, a calendaring device 185, or a notching device 135. The method 1400 can include providing the system 100 that includes a slitting device 410. The method 1400 can include providing the system 100 that includes the separator device 175 and the roller 180. The system 100 can shear a material to form a film 120. The system 100 can laminate the film 120 to a current collector material 125 to form a web 130. The system 100 can provide the web 130 to a notching device 135. For example, the system 100 can provide the web 130 to the notching device 135 directly (e.g., with no intervening components) or via a web handling device 129. The system 100 can include cutting, via the notching device 135, the web 130 to form the singulated electrode 165. The system 100 can include cutting, via the notching device 135, the web 130 to form the tab 235 or the tab 235. The system 100 can include slitting, via the slitting device 410, the web 130 to form a notched web 198. The system 100 can include separating, via the separator device 175, the singulated electrode 165 from the web 130.

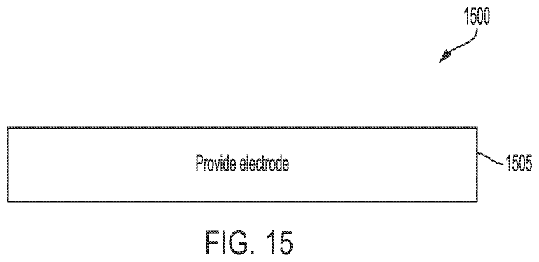

FIG. 15 depicts a flowchart of a method 1500. The method 1500 can include providing an electrode. (ACT 1505.) The method 1500 can include providing an electrode that has been manufactured by the system 100. For example, the method 1500 can include providing the singulated electrode 165. The method 1500 can include providing the electrode portion 305. For example, the method 1500 can include the web 130 including multiple electrode portions 305 or the notched web 198 including at least one electrode portion 305.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, the number of rollers of a calendar-laminator or the orientation of the rollers of the calendar-laminator can be different than as shown and described in the present disclosure. Additional or fewer rollers can be used, for example. Descriptions directional movement (e.g., translation, rotation, or some other movement) can be reversed or otherwise oriented. For example, a conveyor substrate can travel in a direction opposite to, perpendicular to, or at some angle relative to the direction shown and described herein. Elements described as first, second, third, fourth, fifth, etc. elements can instead be labeled as sixth, seventh, eighth, ninth, and tenth for example. Any reference to a component as first, second, third, fourth, or fifth does not imply any particular orientation of the referenced components with respect to each other or with respect to other components. Elements described as negative elements can instead be configured as positive elements and elements described as positive elements can instead be configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to manufacture an electrode, comprising:
a calendaring device including a first roller and a second roller, the calendaring device to apply a force to a material between the first roller and the second roller to form a web, wherein the web comprises an electrode active material adhered to a current collector;
a notching device to cut the web to form the electrode; and
wherein the web is provided from the calendaring device to the notching device.

2. The system of claim 1, comprising:
the notching device comprising a blade coupled with a roller, wherein the blade cuts the web as the roller rotates to form the electrode, wherein the electrode includes a tab.

3. The system of claim 1, wherein the notching device cuts the web to form a first electrode and a second electrode, the system comprising:
the notching device comprising a first blade and a second blade coupled with a roller, the first blade to cut the web as the roller rotates to form the first electrode including a first tab proximate a first edge of the web, the second blade to cut the web as the roller rotates to form the second electrode including a second tab.

4. The system of claim 1, comprising:
the notching device comprising a blade coupled with a roller; and
a backing roller to support the web;
wherein the blade cuts the web with the web between the roller and the backing roller and supported by the backing roller.

5. The system of claim 1, comprising:
the notching device comprising a laser element to cut the web to form a tab of the electrode.

6. The system of claim 1, comprising:
the notching device comprising a blade coupled with a roller; and
a backing roller to support the web and a backing film;
wherein the blade cuts the web with the web between the roller and the backing roller and with the backing film between the web and the backing roller.

7. The system of claim 1, comprising:
the notching device comprising a first laser element and a second laser element, the first laser element to cut the web proximate a first edge of the web to form a first tab, the second laser element to cut the web proximate a second edge of the web to form a second tab.

8. The system of claim 1, comprising:
the notching device comprising a first laser element, a second laser element, and a third laser element, the first laser element to cut the web proximate a first edge of the web to form a first tab, the second laser element to cut the web proximate a second edge of the web to form a second tab, the third laser element to cut the web between the first tab and the second tab.

9. The system of claim 1, comprising:
the web including a first edge and a second edge; and
a slitting device to cut the web between the first edge and the second edge.

10. The system of claim 1, comprising:
the web including a first edge and a second edge; and
a slitting device to cut the web between the first edge and the second edge, wherein the slitting device cuts the web after the notching device cuts the web.

11. The system of claim 1, comprising:
the notching device to cut the web to form a singulated electrode comprising a tab; and
a conveyor device including a roller and a conveyor substrate coupled with the roller, the conveyor device to receive the singulated electrode, wherein a rotation of the roller causes the conveyor substrate to move in a first direction to provide the singulated electrode to a magazine.

12. The system of claim 1, comprising:
the notching device including a backing roller, the notching device to cut the web with the web supported by the backing roller to form a singulated electrode comprising a tab; and
a conveyor device including a roller and a conveyor substrate coupled with the roller, the conveyor device to receive the singulated electrode, wherein a rotation of the roller causes the conveyor substrate to move in a first direction to provide the singulated electrode to a magazine.

13. The system of claim 1, wherein the web includes a plurality of films adhered to a current collector material, the plurality of films spaced apart on the current collector material, the system comprising:
the notching device to cut the web to form a first notched web and a second notched web, the first notched web and the second notched web including a plurality of electrode portions;
a first winding device to wind the first notched web; and
a second winding device to wind the second notched web.

14. The system of claim 1, wherein the notching device cuts the web to form a plurality of electrodes, the system comprising:
a separator device to separate the plurality of electrodes from the web; and
a roller to wind the web with the plurality of electrodes separated.

15. A method, comprising:
applying a force, via a first roller and a second roller of a calendaring device, to a material to form a web, the web including an electrode film adhered to a current collector material;
providing, from the calendaring device, the web to a notching device; and
cutting, via the notching device, the web to form an electrode.

16. The method of claim 15, wherein the notching device cuts the web to form a first tab of a first electrode proximate a first edge of the web and to form a second tab of a second electrode, the method comprising:
cutting, via a slitting device, the web between the first edge and the second edge.

17. The method of claim 15, comprising:
the notching device including a first cutting element, a second cutting element, and a third cutting element, the first cutting element to cut the web proximate a first edge of the web to form a first tab of a first electrode, the second cutting element to cut the web proximate a second edge of the web to form a second tab of a second electrode, the third cutting element to cut the web between the first edge and the second edge.

18. The method of claim 15, wherein the notching device cuts the web to form a plurality of electrodes, the method comprising:
separating, by a separator device, the plurality of electrodes from the web; and
winding, by a roller, the web with the plurality of electrodes separated.

19. An electrode comprising a material adhered to a current collector material, the electrode produced by:
applying a force, via a first roller and a second roller of a calendaring device, to the material and the current collector material to form a web;
providing, from the calendaring device, the web to a notching device; and
cutting, via the notching device, the web to form the electrode.

20. The electrode of claim 19, comprising:
a tab cut by a first cutting element of the notching device,
wherein the electrode is separated from the web via a separator device.
